(19) United States
(12) Patent Application Publication
(10) Pub. No.: US 2025/0250426 A1
(43) Pub. Date: Aug. 7, 2025

(54) POLYMERIC PIPE

(71) Applicant: UPONOR INNOVATION AB, Virsbo (SE)

(72) Inventors: Suresh SHENOY, Bloomington, MN (US); Jacob JOHN, Inver Grove Heights, MN (US); Mats THUNWALL, Fagersta (SE); Shengzhen CAI, Vasteras (SE); Patrik ROSEEN, Vasteras (SE)

(73) Assignee: UPONOR INNOVATION AB, Virsbo (SE)

(21) Appl. No.: 18/751,279

(22) Filed: Jun. 23, 2024

Related U.S. Application Data
(60) Provisional application No. 63/550,882, filed on Feb. 7, 2024.

(30) Foreign Application Priority Data
Mar. 12, 2024 (GB) 2403575.0

(51) Int. Cl. C08L 23/02; B29C 37/00; B29C 48/00; B29C 48/09; B29C 48/91; B29K 23/00; B29K 105/00; B29K 105/16; C08K 5/00; C08K 5/3435; F16L 9/127

(52) U.S. Cl. CPC C08L 23/025; B29C 37/006; B29C 48/022; B29C 48/9105; C08K 5/005; C08K 5/3435; F16L 9/127; B29C 48/09; B29K 2023/06; B29K 2023/065; B29K 2105/0032; B29K 2105/0044; B29K 2105/0085; B29K 2105/0094; B29K 2105/16; C08L 2201/08; C08L 2203/18; C08L 2207/062; C08L 2312/00

(57) ABSTRACT

This invention relates to a polymeric pipe obtained by a peroxide crosslinking process. The pipe is formed from a composition comprising a polyolefin structural polymer, a peroxide initiator in an amount of from about 0.2% to about 5% by weight, and a co-agent in an amount of from about 0.02% to about 5% by weight. The co-agent comprises at least two reactive carbon-carbon double bonds. The invention also relates to methods of forming said pipes. The invention also relates to the use of a co-agent in a composition to reduce bubble formation in a peroxide crosslinking process. The invention also relates to the use of such polymeric pipes for the transport of water.

### CROSS-REFERENCE TO RELATED APPLICATIONS

The present application claims the benefit of U.S. Provisional Application No. 63/550,882 filed on Feb. 7, 2024, entitled POLYMERIC PIPE, and claims the benefit under 35 U.S.C. 119(a), of United Kingdom Patent Application No. 2403575.0, filed on Mar. 12, 2024, both of which are incorporated herein by reference in their entirety.

### TECHNICAL FIELD

This invention relates to a polymeric pipe obtainable by a peroxide crosslinking process. The invention also relates to methods of forming said pipes. The invention also relates to the use of a co-agent in a composition to reduce bubble formation in a peroxide crosslinking process. The invention also relates to the use of the polymeric pipe for the transport of water.

### BACKGROUND

Extruded pipes made from polyolefin polymers are well known for a variety of industrial applications. Typically they are used in the building industry for domestic (e.g. potable) water pipes, radiator pipes, floor-heating pipes and for similar applications in ship building etc. Such pipes can also be used as district heating pipes and as process pipes in the food industry etc. Other applications include the conveyance of gaseous fluids and slurries.

The polyolefin used in extruded pipes is often crosslinked, as this provides a number of advantages. Such advantages include, but are not limited to, long term stability including oxidation resistance, which assists in meeting current codes and standards for potable water applications, flexibility in installation including a “memory effect”, good mechanical properties (including at higher temperatures), etc. Crosslinked polyethylene (PEX) is commonly used for plastic pipes. There are several varieties of PEX that utilize a number of different crosslinking chemistries and processing technologies. Various PEX grades further contain other additives such as antioxidants and/or stabilizer packages in different concentrations and combinations. Specific PEX standards may require specified levels of crosslinking.

The PEX-a process is a variety of PEX production that involves the use of a peroxide initiator to induce crosslinking under the influence of heat and optionally high pressure. The resulting PEX-a composition is crosslinked through carbon-carbon bonds to form the cross-linked polymer network. The PEX-a crosslinking process occurs in the melted stage. The primary reaction is the formation of free radicals upon decomposition of the peroxide, which has to be present by definition for PEX-a, and subsequently, the free radical abstracts hydrogens from the PE polymer chains. The latter gives new carbon radicals, which next combines with neighboring PE chains to form stable carbon-carbon bonds, i.e., crosslinks. The crosslinking, which is considered to be homogeneous and uniform for PEX-a, gives degrees of crosslinking (typically referred to as CCL) in the range of 70-90% for practical applications. Requirement for CCL is to be above 70% for PEX-a as defined in ASTM International Standard for Crosslinked Polyethylene (PEX) Tubing, F 876 (approved Feb. 1, 2022).

Various PEX-a processes are known in the art. These include an Engel method (for example as described in U.S. Pat. No. 3,591,674), a Pipex method (for example methods described in EP 0 678 069), various methods that use infrared heating (for example WO 01/00381, EP 0 921 921, and EP 2 052 830), as well as other methods that utilise heated metal components, ovens or baths to provide crosslinking after extrusion.

It is desirable to provide PEX-a pipes with good long term mechanical properties and that also satisfy hygiene requirements. It can be challenging to satisfy all of these requirements. For example, while relatively high levels of peroxide may increase crosslinking and provide good mechanical properties, the presence of excess peroxide, reaction products, or other reagents in the pipes may result in an odour, or undesirable leaching of components from the pipe.

It is therefore an aim of the present invention to provide a PEX-a or similar pipe having good (and possibly improved) long-term mechanical properties. It is also an aim of the present invention to provide a PEX-a pipe having reduced odour. A further aim is to produce PEX-a pipes for domestic applications which meet or exceed current standards for one or more of burst strength, pressure resistance, degradation, leaching of additives over time, discolouration, flavour, and resistance to chlorine. The present invention may, but is not required, to satisfy some or all of these aims.

### BRIEF SUMMARY OF THE DISCLOSURE

The invention provides extruded polymeric pipes obtainable by a peroxide crosslinking process which benefit from reduced bubble formation relative to existing products currently available.

In accordance with a first aspect of the present invention, there is provided an extruded polymeric pipe obtainable by a peroxide crosslinking process, wherein the pipe is formed from a composition comprising:
a polyolefin structural polymer;
a peroxide initiator in an amount of from about 0.1% to about 5% by weight;
a co-agent in an amount of from about 0.02% to about 5% by weight;
wherein the co-agent comprises at least two reactive carbon-carbon double bonds.

Without wishing to be bound by theory, it is thought the presence of a co-agent in the composition in the given quantities minimises the formation of undesirable bubbles or voids in the polymeric pipe. Such bubbles or voids in the polymeric pipe may have the potential to act as stress concentrators and points for crack initiation. Accordingly, by minimising the formation of these bubbles, enhanced long-term mechanical properties are achieved by the pipes of the present invention. Such long-term stability may be determined according to ASTM F876.

Pipes of the invention may also satisfy the NSF 61 requirements for low levels of leaching and/or long term stability chlorine resistance according to ASTM F2023.

In accordance with a second aspect of the present invention, there is provided a method of forming a polymeric pipe, the method comprising:
providing a mixture to an extruder;
extruding the mixture to form an extruded pipe; and
cross-linking a polyolefin structural polymer by heating the extruded pipe;
wherein the mixture is a composition comprising:
   the polyolefin structural polymer,
   a peroxide initiator in an amount of from about 0.2 to about 5% by weight, and
   a co-agent in an amount of from about 0.02 to about 5% by weight, the co-agent comprising at least two reactive carbon-carbon double bonds.

In accordance with a third aspect of the invention, there is provided a polymeric pipe obtained or obtainable by the method of the second aspect.

In accordance with a fourth aspect of the invention, there is provided a use of a co-agent in a composition to reduce bubble formation in a peroxide crosslinking process, the composition comprising:
a polyolefin structural polymer;
a peroxide initiator in an amount of from about 0.2 to about 5% by weight;
the co-agent in an amount of from about 0.02 to about 5% by weight;
wherein the co-agent comprises at least two reactive carbon-carbon double bonds.

In accordance with a fifth aspect of the invention, there is provided a use of a polymeric pipe of the first aspect, or a polymeric pipe obtained or obtainable by the method of the second aspect, for the transport of water; optionally wherein the water is drinking water.

### BRIEF DESCRIPTION OF THE DRAWINGS

Embodiments of the invention are further described hereinafter with reference to the accompanying drawings, in which:

FIG. 1 is a flowchart illustrating a process for making pipes of the invention.

FIG. 2 is a diagram illustrating an exemplary apparatus that may be used to produce a pipe of the invention.

FIG. 3 shows plots indicating the number of bubbles of a given size per 50 metres of pipes having different amounts of peroxide, produced with and without triallyl cyanurate (TAC). (A) Bubble analysis of a PEX pipe formed from H1878E-C2 PE and 1.6% Trigonox 501 CS40 peroxide initiator (CCL=68.1%) compared to a PEX pipe formed from H1878E-C2 PE, 1.6% Trigonox 501 CS40 peroxide initiator and 0.32% TAC (CCL=82.4%). (B) Bubble analysis of a PEX pipe formed from H1878E-C2 PE and 1.8% Trigonox 501 CS40 peroxide initiator (CCL=73.3%) compared to a PEX pipe formed from H1878E-C2 PE, 1.8% Trigonox 501 CS40 peroxide initiator and 0.36% TAC (CCL=87.9%). (C) Bubble analysis of a PEX pipe formed from H1878E-C2 PE and 1.92% Trigonox 501 CS40 peroxide initiator (CCL=75.9%) compared to a PEX pipe formed from H1878E-C2 PE, 1.92% Trigonox 501 CS40 peroxide initiator and 0.38% TAC (CCL=88.2%).

### DETAILED DESCRIPTION

The abbreviations used herein have their conventional meaning within the chemical and biological arts.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

For the avoidance of doubt, it is hereby stated that the information disclosed earlier in this specification under the heading “Background” is relevant to the invention and is to be read as part of the disclosure of the invention.

All publications, patent applications, patents, and other references mentioned herein are incorporated by reference in their entirety. In case of conflict, the present specification, including definitions, will control.

Polymeric pipes of this invention may be used for a variety of applications, for example, transport of hot and/or cold potable water, radiant floor heating, or waste water, as well being used in fire sprinklers, process pipes in industries such as the food industry, and for conveying fluids other than water such as gases and slurries, among other uses. In some embodiments, these polymeric pipes include a base pipe (e.g. an extruded polymeric pipe obtainable by a peroxide crosslinking process of the invention) with one or more layers disposed on the base pipe. Such additional layer(s) may provide various desired properties, for example oxygen barrier properties, UV light protection, scratch resistance and enhanced mechanical performance and/or long-term stability. In examples, for an oxygen barrier, such additional layers may be produced from thermoplastic non-crosslinked poly(ethylvinylalcohol) or a metallic layer, for example aluminium or stainless steel. Further examples of various layers that may be disposed on a polymeric base pipe are included in US 2010/0084037, entitled “Methods and Compositions for Coating Pipe,” which is incorporated by reference in its entirety. In other embodiments, the polymeric pipe includes the base pipe with no layers disposed on the base pipe, i.e. the pipe will consist of a single (i.e. one) layer.

### Pipe Standards and Certifications

Pipe standards and standard test procedures referenced in the present disclosure include the following:

ASTM International Standard for Crosslinked Polyethylene (PEX) Tubing, F 876-22 (approved 1 Feb. 2022) (“ASTM F876”);

ASTM Standard Specification for Crosslinked Polyethylene (PEX) Hot- and Cold-Water Distribution Systems, F 877-23 (approved 23 Feb. 2023) (“ASTM F877”);

ASTM International Standard Test Method for Evaluating the Oxidative Resistance of Crosslinked Polyethylene (PEX) Tubing and Systems to Hot Chlorinated Water, F2023-10 (approved Aug. 1, 2010) (“ASTM F2023”);

ASTM International Standard Test Method for Obtaining Hydrostatic Design Basis for Thermoplastic Pipe Materials or Pressure Design Basis for Thermoplastic Pipe Products D2837-11 (approved Apr. 1, 2011) (“ASTM D2837”);

ASTM Standard Test Method for Oxidative-Induction Time of Polyolefins by Differential Scanning calorimetry D 3859-98 (approved Jul. 10, 1998) (“ASTM D3895”);

ASTM Standard Test Method for Time-to-Failure of Plastic Pipe Under Constant Internal Pressure, ASTM D1598-21

NSF International Standard/American National Standard/National Standard of Canada for Drinking Water Additives 61-2022 (21 Sep. 2022) (“NSF 61”);

NSF International Standard/American National Standard/National Standard of Canada for Health Effects Evaluation and Criteria for Chemicals in Drinking Water (21 Feb. 2023) (“NSF 600”);
EN ISO 10147 (2011);
DIN EN 1622 (2006);
DN EN 1420 (1999);
DIN EN 12873 (2014);
EN ISO 15875 (2003);
EN ISO 1133 (2022) and;
EN ISO 1167 (2006).

The contents of all of these standards are incorporated herein by reference.

The tests referred to herein are known standard test procedures in the industry and are readily available to the skilled person. We therefore only refer to these tests briefly in the interests of brevity. However, the context of these standards forms an integral part of the invention to the extent that exemplary polymeric pipes of the invention meet or exceed the requirements of the standards. Hence, the content of these standards is explicitly incorporated into the present disclosure by reference.

Presently, PEX tubing in North America must meet temperature and pressure ratings requirements of 160 psi at 73.4° F. (23° C.), 100 psi at 180° F. (82.2° C.), and 80 psi at 200° F. (93.3° C.). Minimum burst ratings are at 475 psi at 73.4° F. (⅝ inch and larger). Additional performance characteristics and requirements for PEX pipes and tubing are given in ASTM F876.

ASTM F876 (North America) and EN ISO 15875 (Europe): Before product launch in relevant markets, any pipes have to pass all required testing in accordance with one of these two standards, respectively. The most time consuming and difficult requirements are mentioned specifically below. In some markets, multilayer pipes may be required to comply with EN ISO 21003.

Temperature/Pressure Ratings: According to NSF/PPI, pipes are only approved (for North America) if they pass 2,000 h of testing without damage. This test is conducted at higher temperature and pressures. Generally, a pipe should not fail if it passes this condition but the pipe still needs to pass 16,000 h for completion.

Chlorine resistance is measured by ASTM F2023 and requires approximately 12-15 months of testing for completion.

A qualitative measure of the level of stabilisation may be provided by the oxidative-induction time (OIT) test, as performed in accordance with ASTM D3895.

Specific additives are typically needed for any application where polymers are utilized to create consumer products. For example, pipes for drinking water applications typically comprise anti-oxidants, crosslinking agents, processing additives, etc. as part of the final pipe composition, regardless of manufacturing method. These additives are typically necessary to provide pipes with desirable physical properties, e.g. pipes that satisfy ASTM F876 and/or EN ISO 15875 requirements. These chemical additives are, however, typically subject to leaching from the final chemical pipe. Leaching of chemicals into water inside the pipe is, however, undesirable. In addition, for certain applications there are limits set on levels of leached chemicals. For example, NSF 61 sets limits on chemical leaching for drinking water pipes.

NSF 61 relates to the hygiene requirement and concerns the need to minimize chemical leaching from the finished pipes. Drinking water pipes in North America must pass the NSF 61 test. The purpose of this test is to assure the customer that the quality of the water inside the pipe is not compromised by chemicals leaching into it. There are three ways to complete this test: 1) single point test, 2) 21-Day multipoint test and 3) 107-Day multipoint test. All three tests involve changing the water inside the pipe over an extended period of time. For the single point test only the water extract on Day 17 is tested. For the multipoint tests the water extracts on several days are analysed and the resulting data is then used to create a decay curve.

The water extracts are analysed by a Gas Chromatograph equipped with a Mass Selective Detector (GC/MS). If deemed necessary other analytical techniques are also used. Twenty-four hours prior to collecting a sample for analysis some of the samples are heated at 82° C. for 30 minutes. The heated extracts are then analysed by GC/MS for semi-volatile compounds using EPA624 method. The rest of the samples are conditioned at room temperature and then analysed by GC/MS for volatile compounds using EPA524 method.

To pass the multipoint tests the concentration of all chemicals extracted into the water must decay to below the Short Term Exposure Limit (STEL) on Day 17 and Total Allowable Concentration (TAC) on Day 107. For the single point test both the STEL and TAC limits must be met on Day 17.

The allowance limits of NSF 61 were typically in the in the ppm range until recent years when the requirements have become more stringent, for example with the limits set in the ppb range for a number of compounds in current NSF standards.

The degree of crosslinking can be quantified in accordance with the following citation from ASTM F876:

“6.7. Degree of Crosslinking-When tested in accordance with 7.9, the degree of crosslinking for PEX tubing material shall be within the range from 65 to 89% inclusive. Depending on the process used, the following minimum percentages crosslinking values shall be achieved: 70% by peroxides [PEX-a], 65% by electron beam [PEX-c], or 65% by silane compounds [PEX-b]”.

Crosslinking may also be performed using other methods, for example a minimum percentage of crosslinking value of 65% by a UV initiator such as benzophenone compounds or azobenzene compounds [PEX-other].

Ideally, pipes should have a high, i.e. at least 50% (preferably at least 65%), level of cross-linking according to the standard. However, in some applications a lower degree of cross-linking may be acceptable.

EN ISO 10147 and EN ISO 15875 also discloses protocols for determining the degree of crosslinking, with the same minimum percentages as described in ASTM F876.

The present invention is able to produce extruded pipes that consistently satisfy a defined target level of crosslinking (CCL) of, for example, at least 65% or at least 70%.

The present invention provides a process for producing pipes that may have a high CCL, i.e. a CCL of at least 70% in a consistent and homogeneous manner, to satisfy or exceed the ASTM F876 standard. Pipes of the invention may satisfy the NSF 61 standard for residuals. Pipes of the invention may have a high CCL and also satisfy the NSF 61 standard for residuals.

DIN EN 12873 provides a test procedure to determine the migration of substances from factory-made products for use in contact with water intended for human consumption.

DIN EN 1622 and DIN EN 1420 provide quantitative methods of analysing the odour and flavour of drinking water and/or migration waters conducted by individual assessors relative to a reference water. If at least 66% of the selected assessors agree that there is no perceived difference between a sample and the reference water, the test is valid.

EN ISO 1133 describes procedures for the determination of the melt mass-flow rate and melt volume-flow rate of thermoplastic materials under specified conditions of temperature and load.

EN ISO 1167 provides a general test method for determining the resistance to internal hydrostatic pressure at a given temperature of thermoplastics pipes, fittings and piping systems for the transport of fluids.

ASTM D1598 discloses a test method for determining the time-to-failure of thermoplastic pipes under constant internal pressure.

ASTM D2837 describes a procedure for estimating long-term hydrostatic strength or pressure-strength via extrapolation with respect to time of a stress-time or pressure-time regression line based on data obtained in accordance with Test Method D1598.

### Definitions

The following explanations of terms and methods are provided to better describe the present disclosure and to guide those of ordinary skill in the art in the practice of the present disclosure.

The term “pipe” as used herein refers to either a pipe (for example as defined in ASTM F2788 and ASTM F2968) or to tubing (for example as defined in ASTM F876). Accordingly, the term “pipe” refers to a polymeric product where the actual outside diameter of the pipe matches that of a steel pipe of the same nominal size (e.g. iron pipe sizing) or where the actual outside diameter matches the nominal size directly. The term “pipe” also refers to a polymeric product where the actual outside diameter is 0.125 inches (3.18 mm) larger than the nominal size (e.g. the same as copper tube sizes (CTS)).

The term “PEX”, unless the context requires otherwise, refers to a cross-linked polyethylene that meets the requirements set out in ASTM F876 or ASTM F877.

The terms “alkyl” and “Cₓ-C_{y} alkyl” (where x is at least 1 and less than 10, and y is a number greater than 10) as used herein include reference to a straight or branched chain alkyl moiety having, e.g. 1, 2, 3, 4, 5, 6, 7, 8, 9 or 10 carbon atoms. The term includes reference to, for example, methyl, ethyl, propyl (n-propyl or isopropyl), butyl (n-butyl, sec-butyl or tert-butyl), pentyl, hexyl and the like. In particular, alkyl may be a “C₂-C₂₄ alkyl”, i.e. an alkyl having 1, 2, 3, 4, 5, 6, 7, 8, 9, 10, 11, 12, 13, 14, 15, 16, 17, 18, 19, 20, 21, 22, 23 or 24 carbon atoms.

Where a compound, moiety, process or product is described as “optionally” having a feature, the disclosure includes such a compound, moiety, process or product having that feature and also such a compound, moiety, process or product not having that feature.

The term “CCL” refers to chemical crosslinking or degree of crosslinking and is equal to the measured gel content, typically expressed as a percentage. Throughout the description and claims of this specification, the phrases “degree of crosslinking”, “level of crosslinking”, “gel content” and or similar mean CCL. CCL may be measured in accordance with known standards, such as per Test Method ASTM D2765 Method B or Test Method ASTM F3203.

The term “STEL” refers to the short term exposure limit. It typically represents the maximum concentration of a contaminant (e.g. a compound) that is permitted by a standard. For example, the NSF 61 standard specifies STEL values that represent the maximum concentration of a contaminant that is permitted in drinking water for an acute exposure calculated in accordance with the standard.

The term “modified polyethylene” may refer to polyethylene modified with one or more functional groups. Exemplary modified polyethylenes include: halogenated polyethylene, polyethylene copolymers with acrylate functional groups (e.g. methyl acrylate, butyl acrylate and the like), polyethylene copolymers with vinyl acetate functional groups, polyethylene co-maleic anhydride, polyethylene copolymers containing glycidyl methacrylate functional groups and the like.

The terms “halo” or “halogen” as used herein includes reference to F, Cl, Br or I. In a particular class of embodiments, halogen is F or Cl.

### Pipes

Unless indicated otherwise in this specification, any reference to a specific component (e.g. polyolefin structural polymer, peroxide initiator, co-agent, hindered amine light stabiliser, antioxidant, or any optional additive) in an amount of % by weight is a reference to the component as a % of its weight relative to the total weight of the composition from which the pipe of the invention is formed.

Pipes may comprise more than one layer. Where the pipe comprises more than one layer, unless the context requires otherwise, reference to a specific component in a in an amount of % by weight is a reference to the component as a % of its weight relative to the total weight of the composition of the relevant layer of the pipe. Pipes of the present invention may be incorporated as a layer in multilayer polymeric or composite (e.g. where the pipe comprises a metal layer as well as plastics layer(s)) in accordance with methods known in the art, for example by adapting methods described in EP 2061638 A1.

For the avoidance of doubt, the amount of each component (e.g. polyolefin structural polymer, peroxide initiator, co-agent, hindered amine light stabiliser, antioxidant, or any optional additive) referred to throughout this disclosure refers to the amount of active component present in the composition, i.e. not including any solvent, stabiliser, or inert component with which the component may be provided. For example, while a peroxide initiator may be provided in admixture with a solvent (e.g. comprising mineral spirits), the amount of peroxide initiator referred to in the compositions from which the pipes of the invention are formed is the amount of the active peroxide species, not including the solvent.

Polymeric pipes of the invention comprise a polyolefin structural polymer. Although the structural polymer may be polyethylene (PE), those of ordinary skill in the art understand that various other structural polymers may be used in place of polyethylene. For example, the structural polymer may be a polyolefin such as PE (e.g., PE-raised temperature, or PE-RT), modified PE; any copolymers thereof; copolymers of PE with polypropylene (PP) and/or polybutylene (PB); polyolefin copolymers such as poly(ethylene-co-maleic anhydride); among other polymers. Exemplary modified PE includes halogenated PE (such as chlorinated PE), polyethylene copolymers with acrylate functional groups (e.g. methyl acrylate, ethyl acrylate, propyl acrylate, butyl acrylate, and the like), polyethylene copolymers with acrylic acid groups (e.g. acrylic acid or methacrylic acid), polyethylene copolymers with vinyl acetate functional groups, polyethylene copolymers with vinyl alcohol groups (e.g. ethylene vinyl alcohol), polyethylene co-maleic anhydride, polyethylene copolymers containing glycidyl methacrylate functional groups, and the like and acid modified PE (such as poly(ethylene-co-maleic anhydride)). For example, the structural polymer may be polyethylene; copolymers of ethylene, with one or more of propylene, 1-butene, 2-butene, 1-pentene, 1-hexene, 1-heptene and 1-octene and isomers thereof with each other and with other unsaturated monomers. Block copolymers and polymer blends of polymerised monomers of any of the abovementioned polymers are also included. The polymeric pipe may have at least about 65% by weight polyolefin structural polymer, at least about 70% by weight polyolefin structural polymer, at least about 75% by weight polyolefin structural polymer, or at least about 65% by weight polyolefin structural polymer. For example, the polymeric pipe may have at least 85% by weight polyolefin structural polymer, at least 90% by weight polyolefin structural polymer, or at least 95% by weight polyolefin structural polymer.

The polyolefin structural polymer may be polyethylene, modified polyethylene, or any copolymers thereof. The polyolefin structural polymer may be polyethylene.

Polyethylene (PE) is classified into several different categories based mostly on its density and branching. The final product performance and mechanical properties depend significantly on variables such as the extent and type of branching, the crystallinity, the density, and the molecular weight and its distribution. PEX pipes are most commonly manufactured from high density polyethylene (HDPE), however, this invention is applicable where any type of polyolefin or polyethylene is used for the production of single-layer or multi-layer plastic pipes such as, but not limited to, low density polyethylene (LDPE), medium density polyethylene (MDPE), PE 100, PE 80, PE-RT grades, and ultra-high molecular weight polyethylene (UHMWPE) or combinations thereof. Examples of commercially available PE that may be used in pipes of the present invention include Basell Q 456, Basell Q 456B, Basell New Resin, Basell Q 471, Basell Lupolen 5261Z Q456, Basell Lupolen 5261Z Q456B, Basell Lupolen 5461B Q471, Basell Lupolen 5461B Q471B (all of which are available from Equistar Chemicals, LP Lyondell Basell Company, Clinton Iowa, United States) Borealis HE 1878, Borealis HE 1878 E, Borealis HE 2550 (all three of which are available from Borealis AG).

The polyolefin structural polymer may be high-density polyethylene (HDPE). For example, the polyolefin structural polymer may be high-density polyethylene (HDPE) having a melt flow index of from about 2 g to about 25 g per 10 minutes (optionally of from about 8 g to about 15 g per 10 minutes), measured according to ISO 1133 at a temperature of 190° C./21.6 kg.

The polymeric pipes of the invention may comprise cross-linked polyethylene (PEX) as the polyolefin structural polymer, in which case the pipe may be a PEX pipe. The structural polymer in such a pipe may comprise or consist of any of the varieties of polyethylene mentioned herein which has been crosslinked by the co-agent.

The pipes of the invention may be pipes, for example PEX pipes, that meet temperature and pressure ratings requirements of 160 psi at 23° C. (73.4° F.), 100 psi at 82.2° C. (180° F.), and 80 psi at 93.3° C. (200° F.). Minimum burst ratings may be at 475 psi at 23° C. (73.4° F.) (⅝ inch and larger).

The compositions from which the polymeric pipes of the invention are formed comprises a peroxide initiator present in an amount of from about 0.1% to about 5% by weight. The peroxide initiator may be present in an amount of from about 0.1% to about 2.5% by weight. The peroxide initiator may be present in an amount of from about 0.2% to about 2.5% by weight. The peroxide initiator may be present in an amount of from about 0.4% to about 2.5% by weight. The peroxide initiator may be present in an amount of from about 0.2% to about 2% by weight. The peroxide initiator may be present in an amount of from about 0.4% to about 2% by weight. The peroxide initiator may be present in an amount of from about 0.2% to about 1.5% by weight. The peroxide initiator may be present in an amount of from about 0.3% to about 1.4% by weight. The peroxide initiator may be present in an amount of from about 0.4% to about 1% by weight.

The peroxide initiator may comprise one or more compound; e.g. at least 1, at least 2, at least 3, at least 4 or at least 5 peroxide initiators as defined herein.

The peroxide initiator may comprise at least two peroxide groups. The peroxide initiator may comprise at least three peroxide groups.

The peroxide initiator may be a cyclic peroxide. For example, the peroxide initiator may be a C₃₋₁₂ cycloalkyl ring interrupted by one or more peroxide groups.

The peroxide initiator may be an acyclic peroxide. For example, the peroxide initiator may comprise a C₆₋₁₈ hydrocarbon chain interrupted by one or more peroxide groups.

The peroxide initiator may be selected from the group comprising: Trigonox 501, Trigonox 301, Trigonox 311, Trigonox 145, Trigonox 101, Trigonox B, and Luperox DTA (ditertamyl peroxide). The peroxide initiator may be Trigonox 501.

Trigonox 501 may be represented by formula

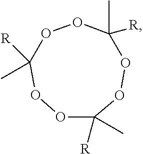

where each R is indepedently selected from C₂ and C₃ alkyl.

Trigonox 301 may be represented by formula

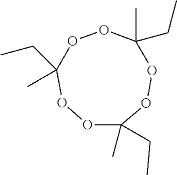 [SMILES: CCC1(C)OOC(C)(CC)OOC(C)(CC)OO1]

which has a molecular weight of 264.3 g/mol.

Trigonox 311 may be represented by formula

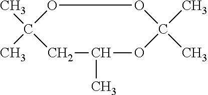

which has a molecular weight of 174.24 g/mol.

Trigonox 145 may be represented by formula

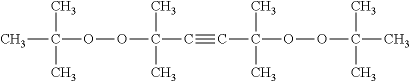 [SMILES: CC(C)(C)OOC(C)(C)C#CC(C)(C)OOC(C)(C)C]

which has a molecular weight of 286.4 g/mol.

Trigonox 101 may be represented by formula

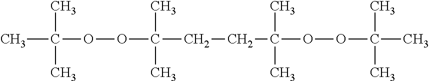 [SMILES: CC(C)(C)OOC(C)(C)CCC(C)(C)OOC(C)(C)C]

which has a molecular weight of 290.4 g/mol.

Trigonox B may be represented by formula

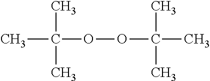

which has a molecular weight of 146.2 g/mol.

Ditertamyl peroxide (Luperox DTA) may be represented by the formula

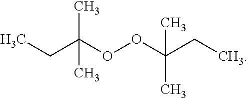

The peroxide initiator induces cross-linking in polyolefin structural polymers under heat and optionally high pressure. This known process is illustrated below for the peroxide initiator Trigonox 501 and polyethylene, and comprises the steps of initiation, hydrogen abstraction and crosslinking. The illustration below can be readily generalised for other peroxide initiators and other polyolefins.

### Initiation:

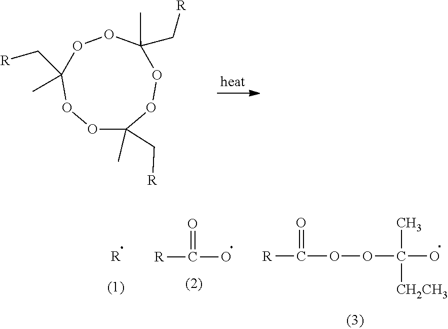

In the initiation step, the Trigonox 501 may decompose into any one of radical species (1), (2) or (3). Further, radical species (1) may combine with radical species (3) to form species (4), which may then break down to form radical species (2), i.e.:

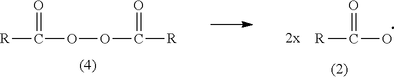

Hydrogen abstraction from the polyethylene chain:

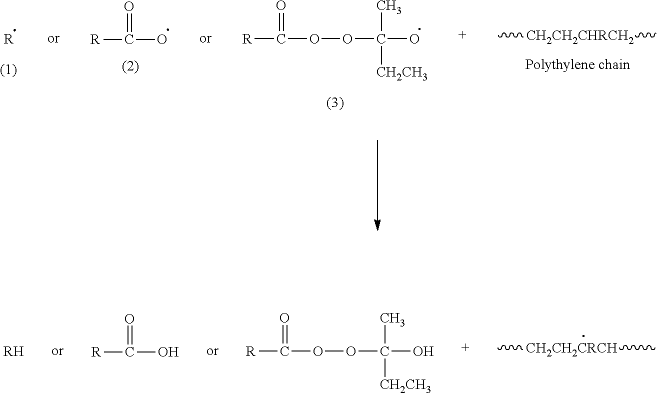

Crosslinking to form a crosslinked polymer network (in this example PEX):

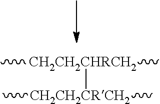

However, it is thought that the use of peroxide initiator alone to provide crosslinking can lead to the undesirable formation of bubbles. As discussed herein, such bubbles may act as stress concentrators and points for crack initiation, thereby potentially negatively impacting the long term mechanical properties of the pipe. Without wishing to be bound by theory, it is thought that, as crosslinking proceeds and the viscosity increases exponentially, the mobility of the polymer molecules decreases, thereby hindering the free radical species from accessing the hydrogen atoms on the polymer chains. As a result, it is thought that hydrogen abstraction is reduced and that the free radical species (a) combine with one another to form volatile organic acetates (i.e. R—C(O)O—R), and/or (b) break down to release carbon dioxide (e.g. radical species (2) breaking down to radical species (1)). It is thought that the production of these volatile organic acetates and/or CO₂ contributes bubble formation.

We have determined that the undesirable formation of bubbles may be reduced by the use of a co-agent. Accordingly, the composition from which the polymeric pipes of the invention are formed comprises a co-agent present in an amount of from about 0.02% to about 5% by weight. The co-agent may be present in an amount of from about 0.05% to about 3% by weight. The co-agent may be present in an amount of from about 0.05% to about 1% by weight. The co-agent may be present in an amount of from about 0.05% to about 0.5% by weight. The co-agent may be present in an amount of from about 0.2% to about 0.5% by weight. The co-agent may be present in an amount of from about 0.3% to about 0.45% by weight.

The co-agent comprises at least two reactive carbon-carbon double bonds. The co-agent may comprise at least three reactive carbon-carbon double bonds. Thus, the co-agent comprises at least two polymerizable carbon-carbon double bonds.

The co-agent provides additional crosslinks between the polyolefin chains of the polyolefin structural polymer. Thus, the co-agent acts to promote and enhance the efficiency of the crosslinking process, e.g. where the polyolefin structural polymer is polyethylene the co-agent enhances the crosslinking of the polyethylene chains to produce PE.

The co-agent may be classed as a Type I or Type II co-agent, depending on the ability of the co-agent to affect the speed of curing and to form reactive radicals.

Type I co-agents are typically polar, low molecular weight multifunctional compositions capable of forming reactive radicals via addition reactions. Exemplary Type I co-agents include: acrylate containing molecules, methacrylate containing molecules, bismaleimides, and biscitraconimide.

Type II co-agents typically form less reactive radicals (primarily via hydrogen abstraction) and contribute to the state of cure. Exemplary type II co-agents include: allyl-containing compounds (e.g. allyl cyanurates, allyl isocyanurates, allyl esters, allyl ethers), homopolymers of dienes (e.g. polybutadienes), copolymers of dienes, vinyl ethers, and mono or polyunsaturated oils.

The co-agent may be selected from or comprise: acrylate, methacrylate, polybutadienes, allyl cyanurates, allyl isocyanurates, allyl esters, allyl ethers, vinyl ethers, and mono or polyunsaturated oils.

In embodiments, the co-agent is a type II co-agent. Thus, the coagent may be selected from or comprise: allyl cyanurates, allyl isocyanurates, allyl esters, allyl ethers, polybutadienes, vinyl ethers, and mono or polyunsaturated oils. The coagent may be selected from or comprise: allyl cyanurates, allyl isocyanurates, allyl esters, or polybutadienes. The coagent may be selected from or comprise: allyl cyanurates or allyl isocyanurates.

The co-agent may comprise a phenyl or triazine moiety and at least two (optionally at least three) reactive carbon-carbon double bonds. The co-agent may comprise an allyl cyanurate, allyl isocyanurate or allyl ester having a phenyl or triazine moiety and at least two reactive carbon-carbon double bonds. For example, the co-agent may comprise an allyl cyanurate, allyl isocyanurate or allyl ester having a phenyl or triazine moiety and at least three reactive carbon-carbon double bonds.

In embodiments, the co-agent is selected from the group comprising: triallyl cyanurate (TAC), triallyl isocyanurate (TAlC), triallyl trimellitate (TATMI), 1,2-polybutadiene. In embodiments, the co-agent is triallyl cyanurate (TAC).

The inventors have found that the presence of a co-agent reduces undesirable bubble formation in the pipes of the invention. Without wishing to be bound by theory, it is thought that the muti-functional (e.g. di, tri, tetra) structure of the co-agent provides alternative sites for hydrogen abstraction which are more accessible to the peroxide radical species than those on the polyolefin structural polymer. This process is illustrated below using triallyl cyanurate (TAC) as an example:

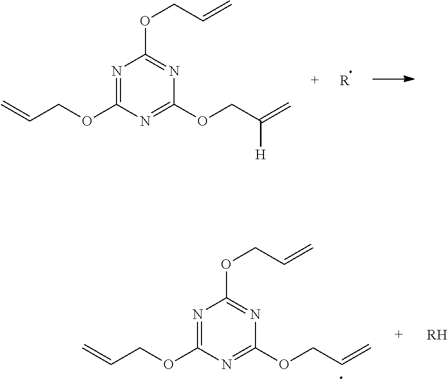

The resulting TAC radical may react with a radical position on the polyethylene chain, resulting in the formation of a crosslinked network.

As a result, it is thought that, rather than reacting with other peroxide radical species to form undesirable volatile organic acetates and/or release carbon dioxide, each peroxide radical may abstract a hydrogen atom from the co-agent to form a low boiling point alkane or an acidic molecule. It is thought that said low boiling point alkanes (e.g. methyl radical can form methane gas) are removed at higher temperatures during the production of the pipe, while said acidic molecules remain in solution in the pipe. Thus, by providing an alternative hydrogen abstraction site for the peroxide radicals, it is thought that the co-agent minimises the reaction of peroxide radicals with one another, reducing volatile by-products and bubble formation. This provides pipes that typically have enhanced long-term mechanical properties.

The weight ratio of peroxide initiator to co-agent in the composition may be in the range of from about 20:1 to about 0.5:1. The weight ratio of peroxide initiator to co-agent in the composition may be in the range of from about 15:1 to about 1:1. The weight ratio of peroxide initiator to co-agent in the composition may be in the range of from about 10:1 to about 1:1. The weight ratio of peroxide initiator to co-agent in the composition may be in the range of from about 5:1 to about 1:1. The weight ratio of peroxide initiator to co-agent in the composition may be in the range of from about 3:1 to about 1:1. The weight ratio of peroxide initiator to co-agent in the composition may be in the range of from about 2.5:1 to about 1:1. The weight ratio of peroxide initiator to co-agent in the composition may be in the range of from about 2:1 to about 1:1. The weight ratio of peroxide initiator to co-agent in the composition may be in the range of from about 2:1 to about 1.2:1.

In a preferred embodiment, the peroxide initiator is Trigonox 501 and the co-agent is triallyl cyanurate (TAC).

The composition may further comprise an antioxidant, for example one or more antioxidants, e.g. at least 1, at least 2, at least 3, at least 4 or at least 5 antioxidants as defined herein. Antioxidants may be used to preserve the polymer blend during the production process, for example when the polymer blend is exposed to the elevated heat and pressure of the extrusion process. Specifically, the mechanical properties of some structural polymers, such as PE, will tend to deteriorate due to oxidative degradation when exposed to heat and pressure. For example, in some cases the deterioration will evidence as the formation of shorter chains, effectively decreasing the average molecular weight of the structural polymer and changing the characteristics of the structural polymer. Antioxidants act to prevent or limit such deterioration.

Antioxidants may also facilitate the maintenance of pipe properties over time, especially when the pipe is exposed to chlorine or other oxidizing agents. In one example, a fluid (e.g. potable water) that is present in the pipe may contain oxidizing agents such as chlorine, which over time may tend to oxidize and break down a structural polymer such as PE. Such oxidation may cause degradation in the properties of the structural polymer and the finished pipe. In some examples, antioxidants tend to preserve the properties of the structural polymer in the presence of an oxidative environment.

The antioxidant may be present in the composition in an amount of from about 0.1% to about 2% by weight. The antioxidant may be present in the composition in an amount of from about 0.2% to about 1% by weight. The antioxidant may be present in the composition in an amount of from about 0.25% to about 0.75% by weight, or from about 0.35% to about 0.55% by weight.

The antioxidant may be a phenolic antioxidant. Examples of such antioxidants are described in WO 2010/138816 A1, which is incorporated by reference in its entirety. For example, WO 2010/138816 A1 discloses, at paragraph on pages 12 to 14, antioxidants that may be used in the pipes of the invention.

The antioxidant may be selected from one or more of:

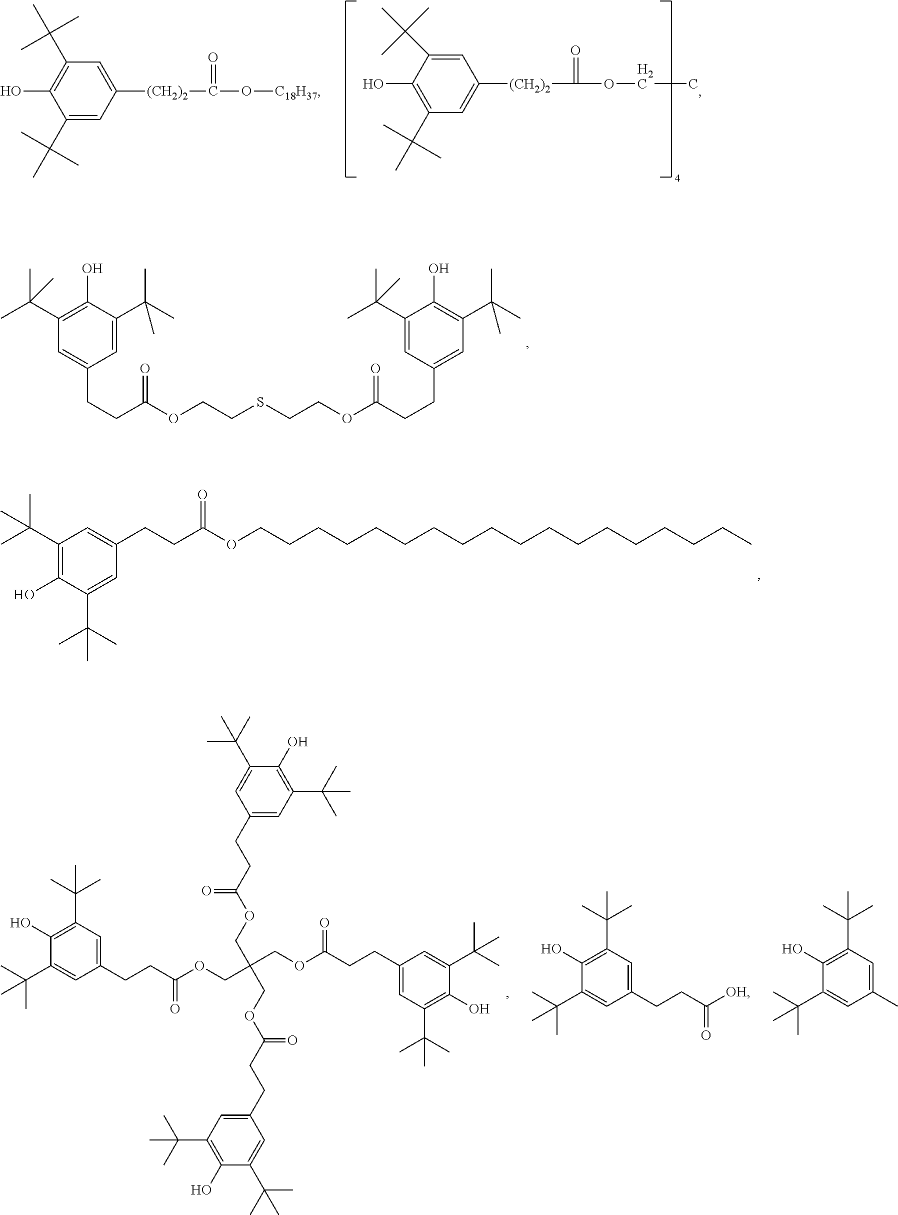

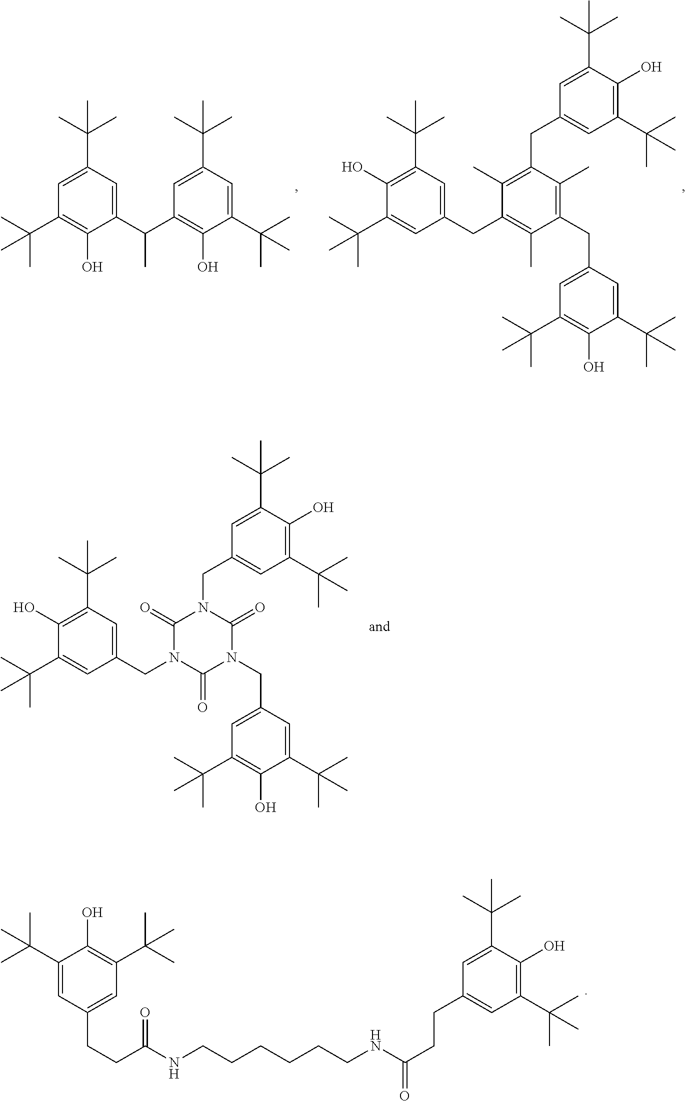

The composition may further comprise a hindered amine light stabiliser (HALS), for example, one or more HALS, e.g. at least 1, at least 2, at least 3, at least 4 or at least 5 HALS as defined herein. HALS are compounds in which an amine group is sterically hindered by adjacent functional groups. The physical properties of structural polymers such as PE may tend to degrade over time when exposed to ultraviolet (UV) wavelengths of light. The use of HALS in the polymer blend interferes with this degradation and facilitates the maintenance of the structural polymer properties over time.

The HALS may be present in the composition in an amount of from about 0.05% to about 1% by weight, from about 0.05% to about 0.5% by weight, from about 0.05 to about 0.3% by weight, from about 0.1 to about 0.25% by weight, or from about 0.1 to about 0.2% by weight, or from about 0.1% by weight to about 0.15% by weight.

Exemplary HALS are described in WO 2010/138816 A1, which is incorporated by reference in its entirety. For example, WO 2010/138816 A1 discloses, at paragraph on pages 15 to 17, HALS that may be used in the pipes of the invention.

The HALS may comprise a piperidine group. In some such embodiments, the HALS may be a compound of the following formula:

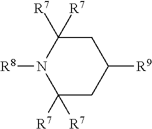

Each R⁷ and R⁸ may be hydrogen or a C₁-C₃₀ saturated or unsaturated aliphatic moiety. R⁹ may be a C₂-C₃₀ saturated or unsaturated straight, branched or cyclic aliphatic moiety such as a hydrocarbon (consisting only of carbon and hydrogen), an ester, an ether, or other suitable functional group.

In some embodiments, at least one of the R⁷ groups at each of the 2 and 6 positions is a C₁-C₃₀ saturated or unsaturated straight, branched or cyclic aliphatic moiety, while in other embodiments both of the R⁷ groups at each of the 2 and 6 positions is a C₁-C₃₀ saturated or unsaturated straight, branched or cyclic aliphatic moiety. In one example, one or both of the R⁷ groups at the 2 and 6 positions in the piperidine ring are alkyl groups (e.g., a methyl or ethyl group), and R⁸ is a hydrogen, methyl or ethyl group.

R⁹ may be a long chain (C₆ or greater, C₈ or greater, C₁₂ or greater, or C₁₆ or greater) straight or branched aliphatic functional group, at least a portion of which is compatible with a nonpolar polyolefin structural polymer such as PE. R⁹ may include an alicyclic structure such as a second piperidine ring. Where R⁹ includes a piperidine ring, a portion of R⁹ may act as a bridge between two piperidine rings. In some such embodiments, the bridge between the two piperidine rings may be a saturated aliphatic moiety or an unsaturated aliphatic moiety (e.g., it may contain a C—C double bond such as methylene). In addition, R⁹ may also be included at other positions on the piperidine ring, for example at any one, any two, or at all three of, the 3, 4 and 5 positions on the piperidine ring.

R⁹ may be an ester of formula —R¹⁰C(O)OR¹¹ or —R¹¹C(O)OR¹⁰. R¹⁰ may be either the piperidine ring (where the ester moiety is attached directly to the piperidine ring) or an additional functional group (e.g., a C₁-C₃₀ saturated or unsaturated aliphatic functional group) that functions as a bridging group between the ester moiety and the piperidine ring. R¹¹ may be a C₂-C₃₀ saturated or unsaturated carbon-containing moiety, for example an aliphatic function group (e.g., a straight, branched or cyclic aliphatic group). R¹¹ together with the carbon atom of the ester moiety may form a C₂-C₃₀ saturated or unsaturated ester.

The hindered amine light stabiliser (HALS) may be selected from or comprise: Cyasorb 3853, Chimassorb 944LD, Tinuvin 770, Tinuvin 622, Chimassorb 2020,

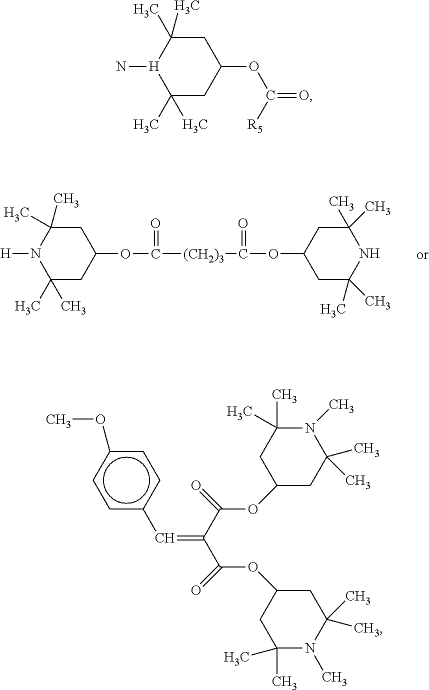

wherein R⁵ is a C₂-C₂₄ alkyl group.

Cyasorb 3853 may be represented by formula

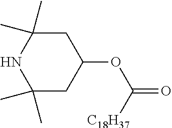

which has a molecular weight of 379 g/mol.

Chimassorb 944LD may be represented by formula

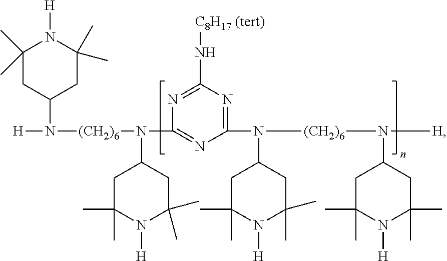

which has a molecular weight of 2000 to 3100 g/mol.

Tinuvin 770 may be represented by formula

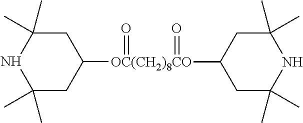

which has a molecular weight of 481 g/mol.

Tinuvin 622 may be represented by formula

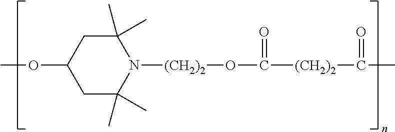

which has a molecular weight of 3100 to 4000 g/mol.

Chimassorb 2020 may be represented by formula

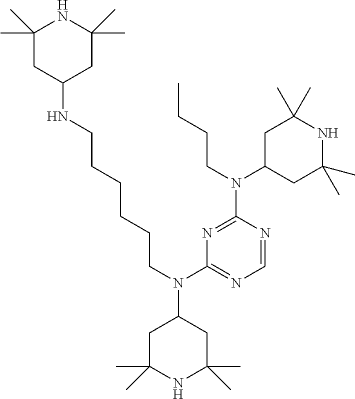

which has a molecular weight of 684.1 g/mol.

Without being bound by any theory, it is thought that the structure of the HALS contributes to reduced leaching from the polymer matrix. For example, it is believed that the relatively long chain fatty acid portions that do not act as bridging groups in the HALS Cyasorb 3853 provide a portion of the compound that is compatible with a polyolefin structural polymer (e.g. a polyethylene). This compatibility provides a level of miscibility and homogeneity in the polymer blend that both improves the burst strength of the finished pipe and prevents and/or reduces the leaching of the Cyasorb 3853 into any water that is resident within the pipe.

Pipes of the invention comprising a HALS and/or an antioxidant may provide an oxidative resistance as measured under the Oxidative Resitance (OR) test (described under the subheading “Assays” below) of greater than 50 years, greater than 75 years, greater than 100 years, greater than 150 years, or greater than 200 years. Certain antioxidant/HALS combinations may also provide greater than 60 minutes, greater than 75 minutes, greater than 90 minutes, greater than 100 minutes, or greater than 125 minutes under the OIT test.

The composition may further comprise one or more additives. The additives may be selected from fillers, processing aids and pigments. The additives may be present at a level (in total) of from about 0.01% to about 15% by weight. For example, the additives may be present at level (in total) of from about 0.01% to about 10% by weight; e.g. from about 0.01% to about 5% by weight.

For example, pipes of the present invention may comprise one or more fillers. The fillers may be selected from nanoparticles (that typically have one dimension below about 200 nm), nanofibers, or other organic fillers, fibres or particles. Exemplary fillers (such as nanoparticles) can be derived from inorganic materials, for example, nano-clays (e.g. intercalated and exfoliated (delaminated) clays (layered silicates)), calcium carbonate, calcium phosphate, aluminium oxide, silicon carbide SiC (nanowhiskers) and silica Si0₂. Preferably at least 50% of the nanoparticles are less than about 20 layers thick, the layers of the nanoparticles having a unit thickness of from about 0.7 nm to 1.2 nm. The nanoparticles may be layered silicates. Polymer-layered silicate composites can be divided into three general types: composites where the layered silicate acts as a normal filler, intercalated nanocomposites consisting of a regular insertion of the polymer material in between the silicate layers and exfoliated nanocomposites where 1 nm-thick layers are dispersed in the polymer material forming a monolithic structure on the microscale. All three types can be used as fillers in the pipes disclosed herein. Layered silicates are believed to be especially beneficial in polymer compositions used to make polymeric pipes in accordance with the invention due to their large surface area in comparison with some other nanoparticles. In this specification, the term “layered silicates” includes natural clays and minerals, for example, montmorillonite and talc, and also synthesized layered silicates such as magadiite, mica, laponite, and fluorohectorite. These layered silicates may be subjected to various surface treatments with organic wetting or coating agents as appropriate to introduce pendant polar groups. Mixtures of different layered silicates, and mixtures of layered silicates with other nanoparticles, may also be used.

The peroxide crosslinking process may be a PEX-a process. For the avoidance of doubt, the term PEX-a process in the context of the invention is not limited solely to the production of crosslinked polyethylene, and may also apply to the use of peroxide initiators for inducing crosslinking in other polyolefin structural polymers or copolymers described herein, e.g. polybutylenes, etc.

The pipe may comprise a chemical crosslink density (CCL) of at least about 60%. The pipe may comprise a chemical crosslink density (CCL) of at least about 65%. The pipe may comprise a chemical crosslink density (CCL) of at least about 70%. The pipe may comprise a chemical crosslink density (CCL) of at least about 75%. The pipe may comprise a chemical crosslink density (CCL) of at least about 80%.

The pipe may comprise a chemical crosslink density (CCL) in the range of from about 65% to about 90%. The pipe may comprise a chemical crosslink density (CCL) in the range of from about 75% to about 90%. The pipe may comprise a chemical crosslink density (CCL) in the range of from about 80% to about 90%. The pipe may comprise a chemical crosslink density (CCL) in the range of from about 82% to about 89%.

The pipe may satisfy the NSF 600-2023 criteria for limits on the concentration of any chemical compound that may migrate into drinking water (e.g. such as those defined in Table 4.1 of NSF 600) when tested in accordance with the analytical methods of NSF 61-2020.

### Methods

In another aspect of the invention, there is provided a method of forming a polymeric pipe, the method comprising:
providing a mixture to an extruder;
extruding the mixture to form an extruded pipe; and
cross-linking a polyolefin structural polymer by heating the extruded pipe;
   wherein the mixture is a composition comprising:
the polyolefin structural polymer,
a peroxide initiator in an amount of from about 0.2% to about 5% by weight, and
a co-agent in an amount of from about 0.02% to about 5% by weight, the co-agent comprising at least two reactive carbon-carbon double bonds.

The composition or pipe may be as further defined in relation to the pipes of the invention or disclosure (for example as described above under the heading “Pipes” and/or for pipes of the first aspect).

The mixture may be prepared by dry mixing the components of the mixture prior to providing the mixture to the extruder. The dry mixing may be performed in a blender or mixer.

The polyolefin structural polymer and co-agent (and optionally other components) may pre-compounded. Said pre-compounded components may be soaked in a solution comprising peroxide to form the mixture prior to providing the mixture to the extruder.

The heating may be performed using at least one infra-red (IR) oven. The heating may be performed directly after extrusion. The IR oven may be in-line with an extruder that performs the extruding.

The extruder may be a twin-screw extruder. For example, the extruder may be a counter-rotating twin screw extruder.

Alternatively, the extruder may be a single screw extruder.

The extruder may comprise a de-gassing component. Without wishing to be bound by theory, the presence of the de-gassing component releases any vapour or other gases in the extruded mixture prior to heating, thereby further reducing the formation of bubbles/voids in the pipe formed from the method.

The extruding may provide an output of at least about 25 kg/h, at least about 40 kg/h, at least about 75 kg/h, at least about 100 kg/h, or at least about 150 kg/h.

The extruding may provide an output of from about 25 to about 500 kg/h. The extruding may provide an output of from about 40 to about 400 kg/h. The extruding may provide an output of from about 75 to about 300 kg/h. The extruding may provide an output of from about 100 to about 250 kg/h. The extruding may provide an output of from about 125 to about 200 kg/h. The extruding may provide an output of about 150 kg/h.

Polyolefin structural polymers are crosslinked by peroxide initiators via a radical based mechanism, such as the mechanism described hereinabove for the exemplary peroxide initiator Trigonox 501. A typical peroxide initiator decomposes into radicals due to the action of heat (and optionally pressure). In view of this, the extruding should preferably be performed at a safe processing temperature which is below a critical temperature at which the given peroxide initiator substantially decomposes into radicals, to minimise crosslinking during the extrusion.

The extruding may be performed below the critical temperature, for example the extruding may be performed at a temperature that is at least about 15° C. lower than the critical temperature, e.g. a temperature that is at least about 30° C. lower than the critical temperature. The extruding may be performed at a temperature that is at least about 40° C. lower than the critical temperature e.g. a temperature that is at least about 50° C. lower than the critical temperature.

The crosslinking will typically be performed at a temperature that is higher than the critical temperature, e.g. the crosslinking may be performed at or above a typical crosslinking temperature for the given peroxide initiator. For example, the crosslinking may be performed at a temperature that is at least about 15° C. higher than the critical temperature, e.g. a temperature that is at least about 30° C. higher than the critical temperature. The crosslinking may be performed at a temperature that is at least about 40° C. higher than the critical temperature, e.g. a temperature that is at least about 50° C. higher than the critical temperature.

The critical temperature may be in the range of from about 180° C. to about 230° C. For example, the critical temperature may be about 180° C., about 190° C., about 200° C., about 210° C., about 220° C., or about 230° C.

The extruding may be performed at a temperature of not more than about 220° C. For example, the extruding may be performed at a temperature of not more than about 200° C.; e.g. the extruding may be performed at a temperature of not more than about 180° C.; or the extruding may be performed at a temperature of not more than about 160° C. The extruding may be performed at or below a safe processing temperature. The safe processing temperature may be not more than about 220° C. For example, the safe processing temperature may be not more than about 200° C.; e.g. the safe processing temperature may be not more than about 180° C. In an example, the safe processing temperature is not more than about 160° C.

The crosslinking may be performed at a temperature of at least about 180° C. For example, the crosslinking may be performed at a temperature at least about 200° C.; e.g. the crosslinking may be performed at a temperature of at least about 220° C. In an example, the crosslinking may be performed at a temperature of at least about 240° C. The crosslinking may be performed at or above a typical crosslinking temperature. The typical crosslinking temperature may be at least about 180° C. For example, the typical crosslinking temperature may be at least about 200° C.; e.g. the typical crosslinking temperature may be at least about 220° C. In an example, the typical crosslinking temperature may be at least about 240° C.

The polymeric pipe may have a diameter in the range of from about 5 mm to about 300 mm. The polymeric pipe may have a diameter in the range of from about 5 mm to about 200 mm. The polymeric pipe may have a diameter in the range of from about 5 mm to about 160 mm. The polymeric pipe may have a diameter in the range of from about 5 mm to about 150 mm. The polymeric pipe may have a diameter in the range of from about 5 mm to about 130 mm. The polymeric pipe may have a diameter in the range of from about 5 mm to about 100 mm.

The formed polymeric pipe may comprise a chemical crosslink density (CCL) of at least about 60%. The formed polymeric pipe may comprise a chemical crosslink density (CCL) of at least about 70%. The formed polymeric pipe may comprise a chemical crosslink density (CCL) of at least about 75%.

The formed pipe may satisfy the NSF 600-2023 criteria for limits on the concentration of any chemical compound that may migrate into drinking water (e.g. such as those defined in Table 4.1 of NSF 600) when tested in accordance with the analytical methods of NSF 61-2020.

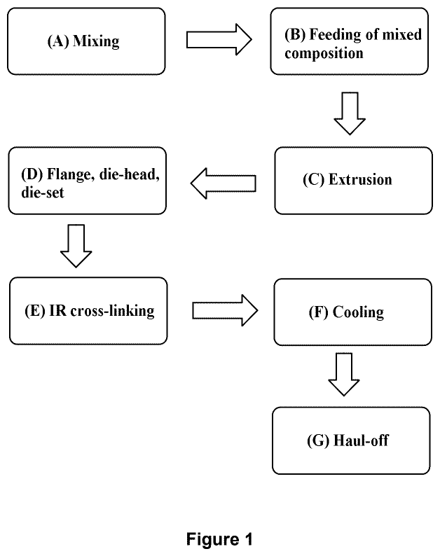

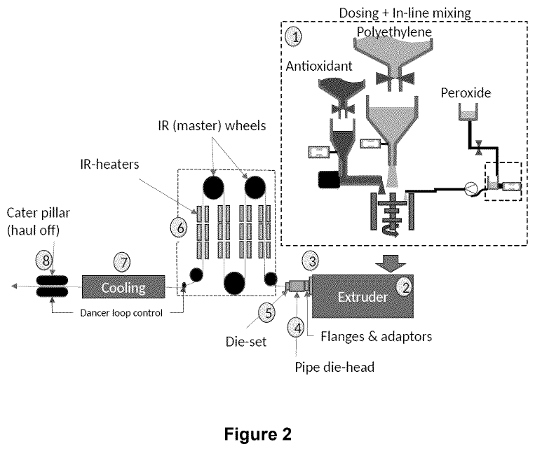

Specific details of apparatus which may be used with the methods of the invention can be seen from the flowchart of FIG. 1. Said apparatus may be arranged “in line” as a single production line, for example, to provide greater convenience. An exemplary apparatus design is depicted in FIG. 2.

(A) Mixing: Polyolefin structural polymer (e.g. HDPE) is mixed with peroxide initiator and co-agent; and optionally one or more of an anti-oxidant (AO), a hindered amine light stabilizer (HALS), processing aid(s) and filler(s), to make up the formulation. These components may be mixed by a separate (e.g. soak) batch mixing process or an in-line mixing process. If a pre compounded (melt mixed) mixture of polyethylene and additives in the form of pellets is provided a soak batch mixing process may be used.

Batch mixing involves mixing desired amount of polyolefin structural polymer, peroxide and co-agent (and optionally one or more of an anti-oxidant (AO), a hindered amine light stabilizer (HALS), processing aid(s) and filler(s)) in a tank with an agitator that mixes the components. The mixture is discharged into a sealed container (cassette) for further processing. Soak batch mixing involves mixing a desired amount of pre-compounded polyethylene material in pellets with peroxide in a vessel and heating said vessel inside an oven for a given period of time. The vessel may be rotated inside the oven to facilitate mixing. After heating, the mixture is cooled for a given period of time and emptied into a cassette for further processing.

In-line mixing involves mixing each of the polyolefin structural polymer, peroxide and co-agent (and optionally one or more of an anti-oxidant (AO), a hindered amine light stabilizer (HALS), filler(s), and other component(s)) as they pass through the mixing system. Thus, each component may be added separately into the system and mixed through the system. This is depicted in the exemplary in-line mixing apparatus 1 of FIG. 2. The co-agent may be mixed with the peroxide prior to injection into the mixing apparatus. For example, the co-agent may be melted and added to the peroxide prior to injection.

(B) Feeding of mixture: The mixed material is fed into the extruder, such as extruder 2 of FIG. 2.

(C) Extrusion: An extruder is used to melt, mix and meter material. Influence on material processing properties can be achieved by altering the screw configuration. Influence on material processing properties can also be achieved separately by running at variable RPM, and/or by changing individual barrel temperature values. High flexibility in output and line speeds are key features of this technology. The extruder may also include a degassing component connected to a vacuum pump to release vapour and other gases. Extruders comprising degassing components may be preferred in some embodiments, as this may further reduce bubble formation.

Any suitable type of extruder may be used. In some examples, the extruder is a counter-rotating twin screw extruder. In other examples, the extruder is a single screw extruder, or a RAM extruder.

(D) Flange, die-head, die-set: The flange may comprise a variety of components for manipulating pipe properties. For example, the flange may comprise a melt pressure probe. The die head may be of a spiral mandrel design and is attached directly after the flange. The die head and die set are the positions on the apparatus where the extruded mixture is shaped into a pipe profile. Thus, the die head and die set are machined to the required dimensions as necessary. FIG. 2 shows an exemplary flange/adaptor 3, pipe de-head 4 and die-set 5 set-up.

(E) IR cross-linking: Directly after the die head, the extruded pipe is introduced to an IR crosslinking oven which allows for high speed, efficient crosslinking. The IR crosslinking oven may comprise a series of IR heaters assembled in a row, adjacent to one another such that the pipe is constantly and consistently being exposed to a controlled level of heat. An exemplary IR crosslinking set-up is depicted at component 6 of FIG. 2.

As the skilled person will appreciate, alternative methods of heating may be used for cross-linking step (E). Examples of alternative methods of heating include a heated metal component (e.g. a heated metal tube or chamber located directly after the die head), a heated salt bath, or the like. For example, the heating may include heating in a salt bath at a temperature of at least 200° C.

(F) Cooling: The cooling may be conducted by a cooling unit, such as cooling unit 7 of FIG. 2. The cooling unit may comprise a row of spray cooling water baths. Further, the pipes may enter the cooling unit via a calibration fixture where the pipe dimensions are calibrated and fixed.

(G) Haul-off: Following cooling, the pipes may be pulled through a haul-off unit (e.g. a caterpillar haul-off, such as component 8 of FIG. 2) to provide the necessary force to pull the pipe through the entire cooling operating without affecting the dimension of the pipe. The haul-off unit typically provides a constant pulling rate to maintain the desired wall thickness of the pipe.

(H) Optional downstream processing: The method may include one or more additional steps after haul-off. For example, the method may further include one or more of:
coating one or more polymeric and/or metal (e.g. aluminium, optionally welded) layers onto the pipes, optionally comprising the use of an adhesive to attach the one or more polymeric and/or metal layers to the pipes and/or to one another;
coating extrusion for pipes with a diffusion barrier using a cross-head, followed by spray cooling;
quality inspection, e.g. via laser dimension control or vision; and
coiling/winding the pipe via a coiler/winder to put the pipe on reels at the end of the production line.

The process is based on the use of a IR cross-linkable pipe formulation where a peroxide initiator is added. The peroxide initiator decomposes under heating to induce crosslinking of the pipe formulation to form crosslinked polyethylene, i.e., PEX. Along with other additives mixed in with the formulation (when present), the presence of the peroxide initiator and co-agent allows the tubing to be crosslinked throughout the entire pipe wall. The pipes of the invention may be formulated according to the compositions and components described herein above. Pipes of the invention may also be formed using the formulations of the examples.

In embodiments of the invention where the extruder is a twin screw extruder, the twin screws used in the extruder can in principle be constructed in two different ways, i.e., with a co-rotating or a counter-rotating design. In the present invention, the twin screw extruder typically has a counter-rotating design. Without wishing to be bound by theory, it is thought that a counter-rotating twin screw extruder provides an efficient material pump, which increases the productivity (line speed) as well as some mixing of materials during the extrusion process.

The counter-rotating twin screws are typically configured with a number of screw elements along the screw axis, which may be combined in a number of different configurations according to the nature of the input raw olefin and additives. The extruder body of counter-rotating twin screws may be constructed of barrels, which can be seen as separate reactors which also provide the flexibility to dedicate one or more specific barrels to perform in certain ways. For example, it is possible to performed direct injection of raw materials into specific zones of the process i.e. into specific barrels. It is also possible to control the conditions in each barrel independently.

Two counter-rotating screws consist of a number of designed screw elements. They are arranged in a design with a number of operative zones, e.g. 4-10 operative zones, throughout the barrel. Each operative zone can have its own design and function (heating, cooling, etc.). The counter-rotating twin screws act as drag flow pumps with forced displacement at intermesh.

The extruder barrel may be equipped with a plurality of individually temperature-controlled zones and a pressure transducer at the inlet to the die head.

A vacuum can be applied in a specific zone, which makes it possible to add components available as slurries or other liquids. For example, the solvent can be removed prior to exit of the extrudate from the twin-screw extruder. Pigments, stabilizers, additional high performance polymers, etc., can also potentially be added sequentially in the extrusion process.

Alternatively, the extruder may be a single screw extruder or a RAM extruder.

The apparatus used in the methods of the invention is flexible in terms of the processing of different materials and dimensions of the produced pipes. For example, the method of the present invention may be performed with an extruder output of greater than 25 kg/h, greater than 40 kg/h, greater than 75 kg/h, greater than 100 kg/h, greater than 125 kg/h or greater than 150 kg/h.

Pipes may be made to any appropriate size. For example, pipe dimensions may be in the range of from about 3 mm to about 460 mm diameter; e.g. pipe dimensions may be in the range of from about 3.2 mm (about ⅛″) to about 457.2 mm (about 18″) diameter. Pipe dimensions may be in the range of from about 12 mm to about 205 mm in diameter; such as in the range of from about 12.7 mm (about ½″) to about 203.2 mm (about 8″) in diameter, e.g. in the range of from about 12.7 mm (about ½″) to about 101.6 mm (about 4″) in diameter.

In another aspect, there is provided a polymeric pipe obtained or obtainable by the methods of the invention.

### Uses

In another aspect, there is provided a use of a co-agent in a composition to reduce bubble formation in a peroxide crosslinking process, the composition comprising: a polyolefin structural polymer; a peroxide initiator in an amount of from about 0.2% to about 5% by weight; the co-agent in an amount of from about 0.02% to about 5% by weight; wherein the co-agent comprises at least two reactive carbon-carbon double bonds.

In another aspect, there is provided a polymeric pipe of the invention, or a polymeric pipe obtained or obtainable by a method of the invention, for the transport of water. The water may be drinking water.

The composition or pipe may be as further defined above under the heading “Pipes” and/or as defined in relation pipes of the first aspect.

The use may comprise extrusion of the composition and/or crosslinking as further defined above under the heading “Methods” and/or as further defined in relation to the second aspect.

### Assays

The pipes of the invention can be assessed in relation to a number of parameters using standard tests that would be known to the person skilled in the art. A number of suitable assays are described below and other suitable assays have been described previously under the heading “Pipe Standards and Certifications”.

### (A) Crosslinking Assay

The degree of crosslinking (CCL) in the pipes of the invention may be analysed according to the chemical method described in ISO 10147, whereby chips of each sample are boiled in xylene and the weight before and after is used to calculate the crosslinking. The degree of crosslinking may also be measured in accordance with the test protocol set out in EN ISO 15875 and ASTM F876. When tested in this manner, a pipe of the invention may have a degree of crosslinking of at least about 70%.

### (B) Hygiene Assay

The preparation of test samples and conditioning protocols (single time point conditioning, i.e., 60° C. and 82° C. conditioning) are in accordance with NSF 61. Day 17 samples were collected and dechlorinated, and subsequently stored in refrigeration before extraction of the target compound.

### Quantification of Triallyl Cyanurate (TAC)

GC/MS Semi-volatile compound analysis using DCM Extraction (Base & Acid extraction) is used to evaluate the TAC. The method is based on EPA 625. Authentic EPA 625 Internal Standards were used for estimation of TAC.

### (C) Hydrostatic Pressure Assay

The hydrostatic pressure testing (HPT) may be carried out according to test methods ISO 1167 or ASTM D1598. Performance requirements are taken from EN ISO 15875 and ASTM F876. Selected pipe samples may be tested at different conditions taken from the EN ISO 15875 QC test conditions described below, or distributed at different hoop stress levels to achieve a time to failure distribution from 1 h and upwards.
EN ISO 22 h test at 95° C. (203° F.) (water in water) with hoop stress 4.7 MPa
EN ISO 165 h test at 95° C. (203° F.) (water in water) with hoop stress 4.6 MPa
EN ISO 1000 h test at 95° C. (203° F.) (water in water) with hoop stress 4.4 MPa

The ASTM F876 1000 h test is at a hoop stress of 4.48 MPa (650 psi) and 200° F. (93° C.). The corresponding EN ISO requirement at 200° F. (93° C.) gives a hoop stress of 4.49 MPa (651 psi). Failure mode transition from ductile to brittle is taken as an indication of decreasing crack propagation resistance.

### (D) Bubble Analysis Assay

Number and size of bubbles (voids) were quantified (and characterized) by analysing pictures taken by a camera following pipe production. The system recorded 50 pictures per second. The pictures were then exported to a PC where software object detection (deep learning) was used to analyse the recorded data. Here, the bubbles (voids) were detected, classified (by size) and quantified over time. By assuming even distribution of the bubbles over the pipe circumference, the number of bubbles for each size category per 50 metre of produced pipe could be obtained and used for evaluating the processing.

### (E) Stabiliser Functionality Assays

Stabiliser functionality testing is a measure of resistance to oxidative degradation and provides an indication of the long-term performance of pipes (e.g. PEX pipes), in relation to oxidative degradation, e.g. by chlorine in potable water.

One method for testing the stability of a pipe in the presence of an oxidizing agent is the Oxidative Induction Time (OIT) test. In this test, a sample of the pipe material is placed in a DSC and held at a constant temperature of 200° C. in an oxygen-rich atmosphere. The amount of time to the induction of polymer degradation is measured. A longer time before a change in heat flow is observed indicates that the sample would be relatively more stable in the presence of an oxidizing agent. The test method for the OIT test is ASTM-D3895, which is herein incorporated by reference in its entirety.

Another test that is performed on pipe samples to evaluate oxidative resistance is called the Oxidative Resistance (OR) test (also known as the ASTM F2023 chlorine resistance test). This test is described in ASTM F 2023, which is incorporated herein by reference in its entirety. This test places chlorinated water in a pipe under a number of different combinations of elevated pressure and temperature until the pipe fails. The time until failure of the pipe at the different combinations of temperature and pressure is used to estimate the life of the pipe.

### Additional Embodiments

The disclosure also includes the embodiments of the following numbered clauses:

1. An extruded polymeric pipe obtainable by a peroxide crosslinking process, wherein the pipe is formed from a composition comprising:
a polyolefin structural polymer;
a peroxide initiator in an amount of from about 0.1% to about 5% by weight;
a co-agent in an amount of from about 0.02% to about 5% by weight;
wherein the co-agent comprises at least two reactive carbon-carbon double bonds.

2. The polymeric pipe of clause 1, wherein the polyolefin structural polymer is polyethylene, a modified polyethylene, and any copolymers thereof.

3. The polymeric pipe of clause 1 or clause 2, wherein the polyolefin structural polymer is high-density polyethylene (HDPE) having a melt flow index of from about 2 to about 25 g/10 minutes, measured according to ISO 1133 (2022) at a temperature of 190° C./21.6 kg.

4. The polymeric pipe of any preceding clause, wherein the peroxide initiator comprises at least two peroxide groups.

5. The polymeric pipe of any preceding clause, wherein the peroxide initiator is selected from the group comprising: Trigonox 501, Trigonox 301, Trigonox 311, Trigonox 145, Trigonox 101, Trigonox B, and diteramyl peroxide; optionally wherein the peroxide initiator is Trigonox 501.

6. The polymeric pipe of any proceeding clause, wherein the peroxide initiator is a cyclic peroxide.

7. The polymeric pipe of any preceding clause, wherein the co-agent comprises at least three reactive carbon-carbon double bonds.

8. The polymeric pipe of any preceding clause, wherein the co-agent is selected from or comprises acrylates, methacrylates, polybutadienes, allyl cyanurates, allyl isocyanurates, allyl esters, allyl ethers, vinyl ethers and mono or polyunsaturated oils.

9. The polymeric pipe of any preceding clause, wherein the co-agent is a type II co-agent.

10. The polymeric pipe of any preceding clause, wherein the co-agent comprises a phenyl or triazine moiety and at least three reactive carbon-carbon double bonds.

11. The polymeric pipe of clause 7, wherein the co-agent is selected from the group comprising: triallyl cyanurate (TAC), triallyl isocyanurate (TAlC), and triallyl trimellitate (TATMI).

12. The pipe of any preceding clause, wherein the weight ratio of peroxide initiator to co-agent is in the range of from about 20:1 to about 0.5:1, optionally from about 2.5:1 to about 1:1.

13. The pipe of any preceding clause, wherein the composition further comprises an antioxidant in an amount of 0.1% to 2% by weight.

14. The pipe of clause 13, wherein the antioxidant is at least one phenolic antioxidant.

15. The pipe of clause 13 or clause 14, wherein the antioxidant is selected from one or more of:

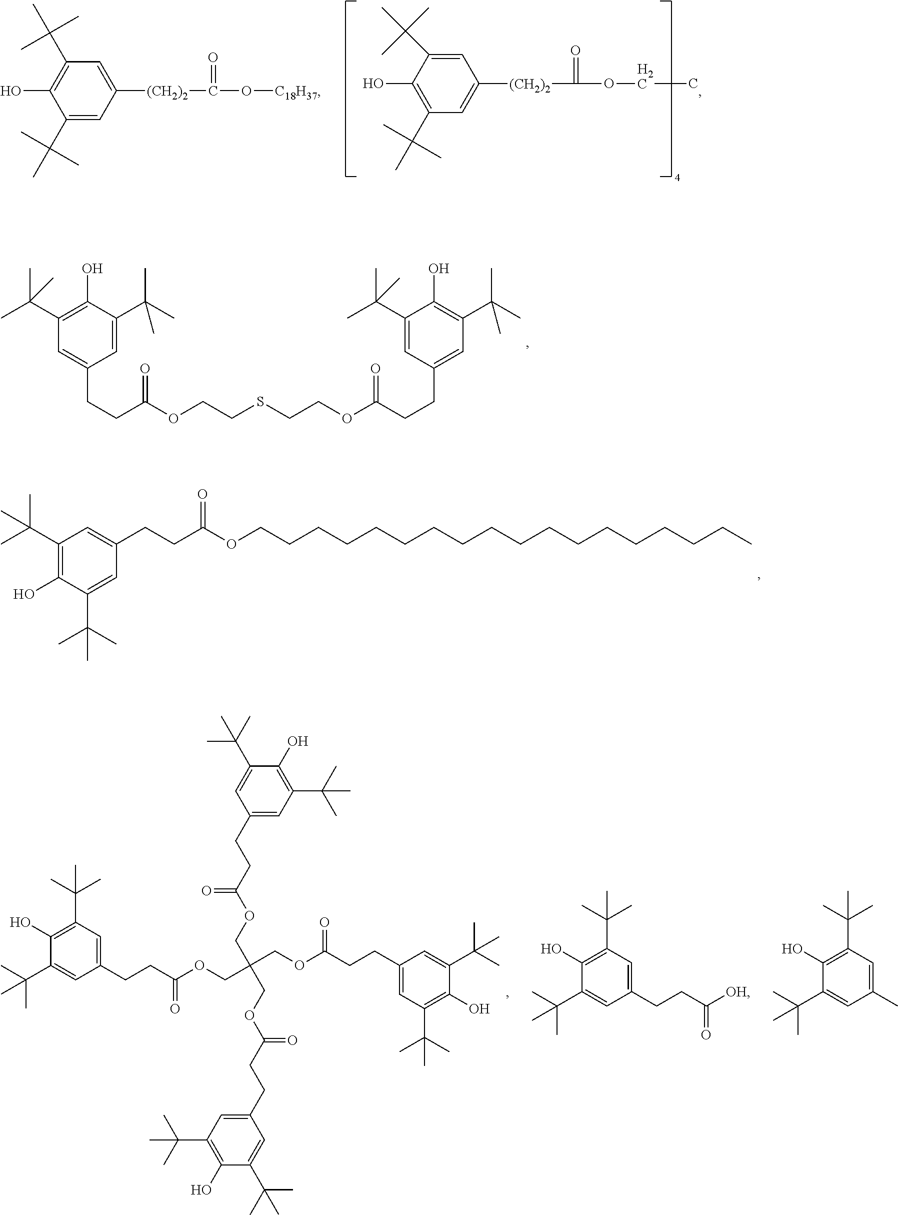

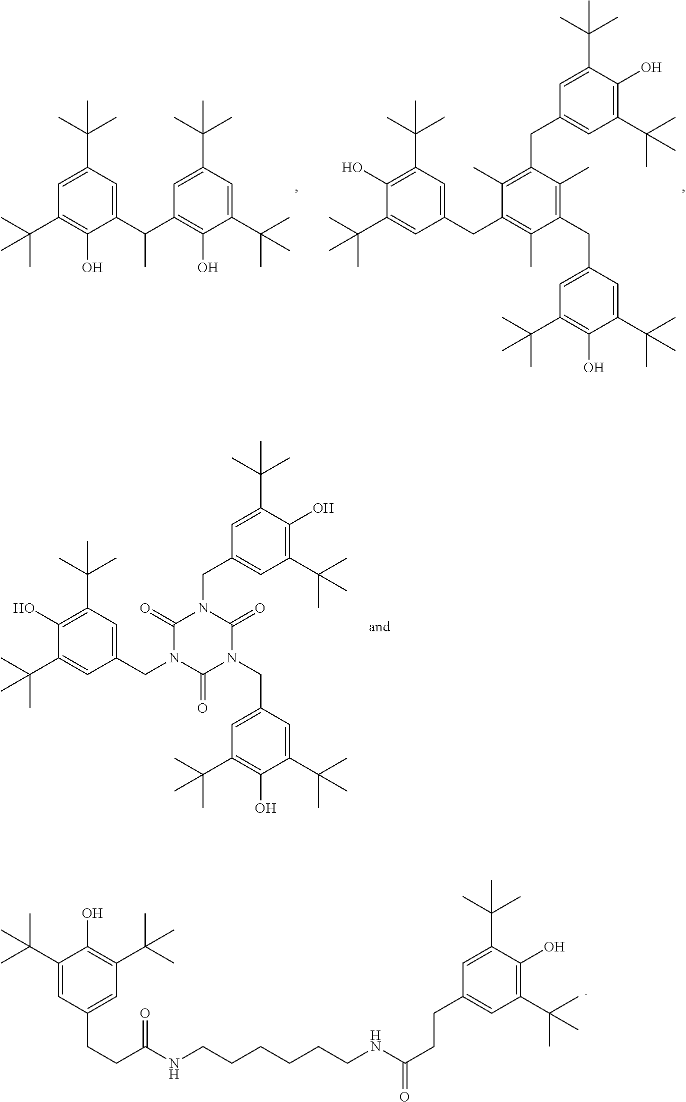

16. The pipe of clause 14 or 15, wherein the antioxidant is in an amount of 0.2% to 1% by weight.

17. The pipe of any preceding clause, wherein the composition further comprises a hindered amine light stabiliser (HALS) in an amount of 0.05% to 1% by weight.

18. The pipe of clause 17, wherein the hindered amine light stabiliser is selected from or comprises:
Cyasorb 3853, Chimassorb 944LD, Tinuvin 770, Tinuvin 622, Chimassorb 2020,

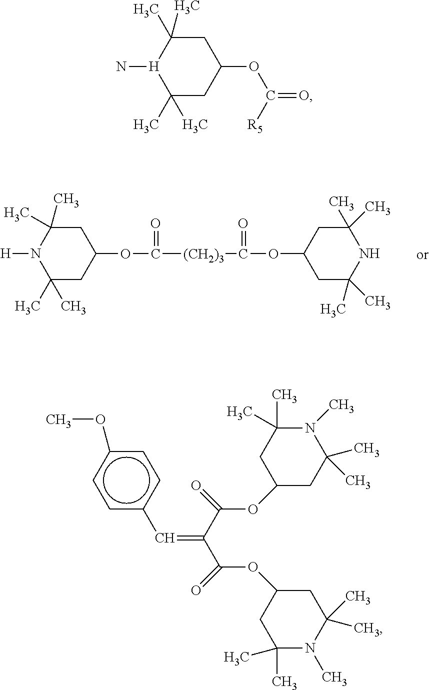

wherein R⁵ is a C₂-C₂₄ alkyl group.

19. The pipe of clause 17 or clause 18, wherein the hindered amine light stabiliser is present in an amount of from about 0.05% to about 0.3% by weight of the composition.

20. The pipe of any preceding clause, wherein the composition further comprises one or more additives selected from fillers, processing aids and pigments, optionally wherein said one or more fillers are selected from nanoparticles, nanofibers, or other organic fillers, fibres or particles.

21. The pipe of any preceding clause, wherein the peroxide crosslinking process is a PEX-a process.

22. The pipe of any preceding clause, wherein the pipe comprises a chemical crosslink density (CCL) of at least about 60%, optionally a CCL of at least about 70%, further optionally a CCL of at least about 75%; and/or
wherein the pipe satisfies the NSF 600-2023 criteria for limits on the concentration of any chemical compound (optionally tert-butyl alcohol) that may migrate into drinking water when tested in accordance with the analytical methods of NSF 61-2020.

23. A method of forming a polymeric pipe, the method comprising:
providing a mixture to an extruder;
extruding the mixture to form an extruded pipe; and
cross-linking a polyolefin structural polymer by heating the extruded pipe;
wherein the mixture is a composition comprising:
   the polyolefin structural polymer,
   a peroxide initiator in an amount of from about 0.2% to about 5% by weight, and
   a co-agent in an amount of from about 0.02% to about 5% by weight, the co-agent comprising at least two reactive carbon-carbon double bonds.

24. The method of clause 23, wherein the composition is as further defined for the pipe of any of clauses 2 to 20.

25. The method of clause 23 or 24, wherein the mixture is prepared by dry mixing the components of the mixture prior to providing the mixture to the extruder;
optionally performing the dry mixing in a blender/mixer.

26. The method of clause 23 or 24, wherein the polyolefin structural polymer and co-agent (and optionally other components) are precompounded and said precompounded components are soaked in a solution comprising peroxide to form the mixture prior to providing the mixture to the extruder.

27. The method of any of clauses 23 to 26 wherein the heating is performed using at least one infra-red (IR) oven, optionally directly after extrusion.

28. The method of clause 27, wherein the IR oven is in-line with an extruder that performs the extruding, optionally wherein the extruder is a twin-screw extruder, such as a counter-rotating twin screw extruder.

29 The method of any of clauses 23 to 28, wherein the extruder comprises a de-gassing component.

30. The method of any of clauses 23 to 29, wherein the extruding provides an output of from about 25 to about 500 kg/h; and/or
wherein the polymeric pipe has a diameter in the range of from about 5 mm to about 300 mm.

31. The method of any of clauses 23 to 30, wherein the formed polymeric pipe comprises a chemical crosslink density (CCL) of at least about 60%, optionally a CCL of at least about 70%, further optionally a CCL of at least about 75%; and/or
wherein the pipe satisfies the NSF 600-2023 criteria for limits on the concentration of any chemical compound that may migrate into drinking water (optionally tert-butyl alcohol) when tested in accordance with the analytical methods of NSF 61-2020.

32. A polymeric pipe obtained or obtainable by the method of any of clauses 23 to 31.

33. Use of a co-agent in a composition to reduce bubble formation in a peroxide crosslinking process, the composition comprising:
a polyolefin structural polymer;
a peroxide initiator in an amount of from about 0.2 to about 5% by weight;
the co-agent in an amount of from about 0.02 to about 5% by weight;
wherein the co-agent comprises at least two reactive carbon-carbon double bonds.

34. Use of a polymeric pipe of any of clauses 1 to 22 or 32, or a polymeric pipe obtained or obtainable by the method of any of clauses 23 to 30, for the transport of water; optionally wherein the water is drinking water.

### EXAMPLES

### Materials and Methods

The raw materials used in this study are listed in Table 1.

Borealis HE1878E-C2 (C2) is a highly stabilized form of polyethylene. C2 is intended for applications where chlorine and UV classification/rating according to ASTM F876 is needed.

Trigonox 501 (T501) peroxide were obtained from Nouryon at a specified percentage in white spirits.

Co-agent 2,4,6-Triallyloxy-1,3,5-triazine (TAC) is a trifunctional monomer which can easily polymerize. According to NSF 600, the limit of TAC is 0.1 mg/l or 100 ppb (Total Allowable Concentration & STEL).

TABLE 1
Raw materials used in the examples

| | | | | Form | |
|---|---|---|---|---|---|
| Material | Name | CAS no. | Supplier | at RT | Note |
| HDPE | HE1878E-C2 | 9002-88-4 | Borealis | Mini- | Fully |
| | | | | pellet | formulated |
| | | | | | compound, |
| | | | | | MFI = 9 |
| Peroxide | Trigonox | 1613243-54-1 | Nouryon | Liquid | 30% PO in |
| | 501-CS30 | | | | white spirits |
| Peroxide | Trigonox | 1613243-54-1 | Nouryon | Liquid | 40% PO in |
| | 501-CS40 | | | | white spirits |
| Co-agent | TAC (2,4,6- | 101-37-1 | Evonik | Solid | Melt at = |
| | Triallyloxy- | | | | 27° C. |
| | 1,3,5-triazine) | | | | |

### Example 1: Manufacture of Pipes

Exemplary pipes were manufactured according the following set up. High-density polyethylene (Borealis 1878E-C₂), Trigonox 501 CS40 peroxide (Nouryon) and TAC (Evonik) were mixed together in an in-line mixing station. The mixture was then fed into a 90 mm counter-rotating twin-screw extruder to melt, mix and meter the material. Once extruded, the extruded mixture was then passed through a flange, pipe-die-head and die-set to generate a shaped approximately ½″ pipe profile. The extruded pipe was then transited through an IR cross-linking oven, reaching a temperature of about 250° C., to generate a cross-linked pipe (PEX pipe). The PEX pipe was then cooled in a vacuum spray cooling tank and hauled off using an caterpillar.

Pipes having different levels of Trigonox 501 and TAC were synthesised and subsequently tested. The amount of Triognox 501 and TAC in the synthesised pipes are disclosed in Table 2.

TABLE 2
amount of peroxide and co-agent in the synthesised pipes

| Sample | Trigonox 501-CS40 | TAC | Ratio* |
|---|---|---|---|
| No. | (% w/w) | (% w/w) | Trigonox 501:TAC |
| 1 | 1.55 | 0.05 | 12.4:1 |
| 2 | 2.0 | 0.06 | 13.3:1 |
| 3 | 1.6 | 0.32 | 2:1 |
| 4 | 1.8 | 0.36 | 2:1 |
| 5 | 1.92 | 0.383 | 2:1 |
| 6 | 1.6 | 0 | |
| 7 | 1.8 | 0 | |
| 8 | 1.92 | 0 | |
| 9 | 1.2 | 0.4 | 1.2:1 |
| 10 | 1.35 | 0.45 | 1.2:1 |

*Ratio based on amount of active compound, i.e. takes into account that CS40 comprises 40% active Triganox 501.

### Example 2: Chemical Cross-Linking (CCL) Analysis

The degree of cross-linking (CCL) for each pipe was determined in accordance with the above described cross-linking assay. The results of this assay are depicted in Table 3 below.

| Sample | Trigonox 501-CS40 | TAC | |
|---|---|---|---|
| No. | (% w/w) | (% w/w) | CCL (%) |
| 1 | 1.55 | 0.05 | 75.49 |
| 2 | 2.0 | 0.06 | 84.31 |
| 3 | 1.6 | 0.32 | 82.48 |
| 4 | 1.8 | 0.36 | 87.9 |
| 5 | 1.92 | 0.383 | 88.24 |
| 6 | 1.6 | 0 | 68.15 |
| 7 | 1.8 | 0 | 73.25 |
| 8 | 1.92 | 0 | 75.85 |
| 9 | 1.2 | 0.4 | 86.07 |
| 10 | 1.35 | 0.45 | 83.68 |

At a peroxide concentration of 0.64% (1.6% Trigonox 501-CS40) in the absence of TAC co-agent (Sample 6), a CCL of less than 70% was achieved. However, an overall improvement in CCL was observed when TAC was added. For example, adding as low as 0.05% or 0.06% TAC together with 0.62% or 0.8% peroxide (1.55% or 2.0% Trigonox 501-CS40) achieved a CCL of greater than 75% (Samples 1 and 2).

Further, while formulations comprising at least 0.7% w/w peroxide (1.8% w/w Trigonox 501-CS40) in the absence of TAC (Samples 7 and 8) achieved an acceptable cross-linking level of greater than 73%, the addition of TAC into these formulations (Samples 4 and 5) resulting in a CCL of greater than 80%. Similar results were observed in formulations having 0.64% peroxide (1.6% Trigonox 501-CS40) and 0.32% TAC, i.e. with a peroxide: coagent weight ratio of 2:1.

Further studies of the levels of peroxide and co-agent found that high CCL (e.g. greater than 83%) may be achieved using lower concentrations of peroxide in a peroxide: co-agent ratio of about 1.2:1 (Samples 9 and 10).

### Example 3: Bubble Analysis

The number of bubbles detected per 50 metres of each pipe of Samples 1 to 10 is shown in Table 4.

TABLE 4

| | Average number of bubbles of given size | | | | | | |
|---|---|---|---|---|---|---|---|
| Sample | 0.3 mm | 0.4 mm | 0.65 mm | 0.87 mm | 1.1 mm | 1.3 mm | 2 mm |
| 1 | 30.0 | 125 | 14.8 | 0.6 | 0.7 | 0.6 | 0.2 |
| 2 | 43.1 | 354 | 53.3 | 3.2 | 1.0 | 0.8 | 0.2 |
| 3 | 12.8 | 32.1 | 8.5 | 0.8 | 0.5 | 0.2 | 0.2 |
| 4 | 9.2 | 21.2 | 3.4 | 0.2 | 0.4 | 0.1 | 0.0 |
| 5 | 9.0 | 71.8 | 1.6 | 0.3 | 0.0 | 0.0 | 0.0 |
| 6 | 29.2 | 201 | 35.5 | 1.4 | 1.1 | 0.5 | 0.4 |
| 7 | 26.2 | 680 | 211 | 6.9 | 1.8 | 0.8 | 0.3 |
| 8 | 26.9 | 884 | 326 | 14.7 | 2.4 | 0.8 | 0.2 |
| 9 | 3.9 | 6.5 | 0.0 | 0.0 | 0.0 | 0.0 | 0.0 |
| 10 | 2.8 | 21.7 | 3.0 | 0.1 | 0.0 | 0.0 | 0.0 |

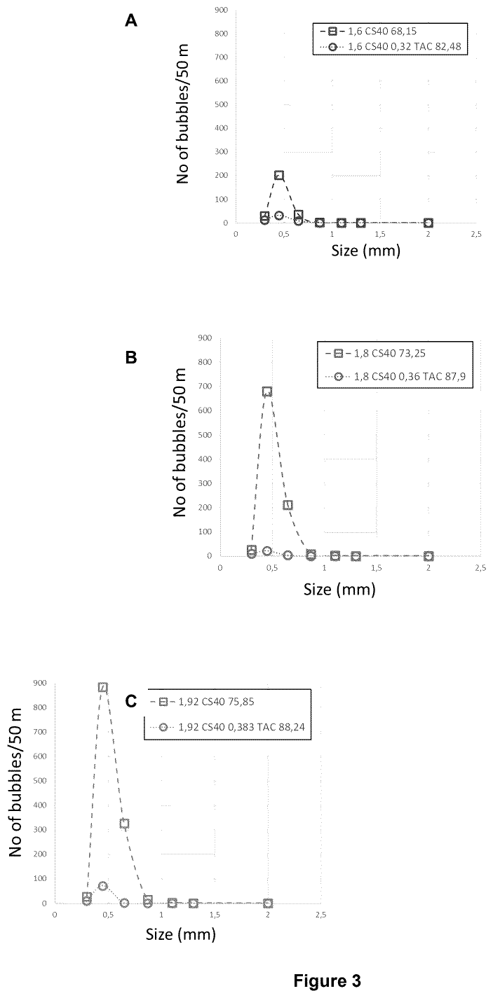

In samples 6, 7 and 8 (containing no TAC and 0.64%, 0.72% and 0.77% peroxide, respectively), a large number of small and medium sized bubbles were observed, particularly 0.4 mm and 0.65 mm bubbles. In contrast, when TAC was added to these formulations in a ratio of 1:2 by weight of TAC: peroxide (Samples 3-5), a significant reduction in the numbers of bubbles was achieved. See FIG. 3.

A further reduction in the number of bubbles was observed when the amount of peroxide was decreased to a peroxide: TAC weight ratio of 1.2:1 (Samples 9 and 10), with no bubbles of greater than 0.87 mm observed. This is particularly beneficial, as larger bubbles (e.g. of 1.1 mm or greater) are expected to have a more significant effect than smaller bubbles on mechanical and other pipe properties.

Further, as shown for Samples 1 and 2, the presence of low amounts of TAC (i.e. 0.05% or 0.06%) resulted in a reduced in the number of bubbles, particularly in the size range of 0.45 to 1.1 mm.

### Example 4: Hygiene Testing

Drinking water pipes need comply with hygiene requirements, such as NSF 600 (as discussed herein). The pipes of the present invention were tested and comply with these hygiene requirements, as explained below.

According to the NSF 600, the STEL (Short Term Exposure Limit) for triallyl cyanurate (TAC) is 100 ppb. As shown in the Table 5, the TAC migrated from pipes were below the limit set by the NSF.

TABLE 5

| migration | | | PX | TAC | CCL | TAC | TAC | ≥size 36 |
|---|---|---|---|---|---|---|---|---|
| temp | Material | PX(%) | type | (%) | (%) | (ppb) | (STEL, ppb) | bubbles/50 m |
| 60° C. | HE1878E-C2 | 0.8 | CS40 | 0.8 | 82.16 | 9.1 | 100 | 3.6 |
| 82° C. | | | | | | 47.7 | | |
| 60° C. | HE1878E-C2 | 0.75 | CS40 | 0.25 | 70.14 | 2.2 | | 1.1 |
| 82° C. | | | | | | 7.0 | | |
| 60° C. | HE1878E-C2 | 1.125 | CS40 | 0.375 | 80.21 | 2.4 | | 2.5 |
| 82° C. | | | | | | 3.5 | | |
| 60° C. | HE1878E-C2 | 1.5 | CS40 | 0.5 | 84.13 | 1.2 | | 0.7 |
| 82° C. | | | | | | 1.4 | | |

A continued TAC study using the extrusion process described in Example 1 were carried out. Migration was conducted on four samples with different ratios of TAC to T501. The TAC migrated from pipes in the migration water were below the limit set by the NSF600, when tested in accordance with NSF61.

Sensory evaluation (taste and odour) was performed by using an un-forced paired test according to the standards DIN EN 1420 and DIN EN 1622. According to the evaluation criteria for plastics and other organic materials in contact with drinking water (KTW-BWGL), for ½″ pipes in the drinking water system, the TON≤8 at day 10 (TON≤16 to proceed to extend to day 31) and TON≤8 at day 31. Adding the TAC significantly reduced the odour level compared to the formulation without TAC.

1. An extruded polymeric pipe obtainable by a peroxide crosslinking process, wherein the pipe is formed from a composition comprising:
a polyolefin structural polymer;
a peroxide initiator in an amount of from about 0.1% to about 5% by weight;
a co-agent in an amount of from about 0.02% to about 5% by weight;
wherein the co-agent comprises at least two reactive carbon-carbon double bonds.

2. The polymeric pipe of claim 1, wherein the polyolefin structural polymer is polyethylene, a modified polyethylene, and any copolymers thereof; and/or
wherein the polyolefin structural polymer is high-density polyethylene (HDPE) having a melt flow index of from about 2 to about 25 g/10 minutes, measured according to ISO 1133 (2022) at a temperature of 190° C./21.6 kg.

3. The polymeric pipe of claim 1, wherein the peroxide initiator comprises at least two peroxide groups; and/or
wherein the peroxide initiator is a cyclic peroxide.

4. The polymeric pipe of claim 1, wherein the peroxide initiator is selected from the group comprising: Trigonox 501, Trigonox 301, Trigonox 311, Trigonox 145, Trigonox 101, Trigonox B, and diteramyl peroxide.

5. The polymeric pipe of claim 1, wherein the co-agent comprises at least three reactive carbon-carbon double bonds.

6. The polymeric pipe of claim 1, wherein the co-agent is selected from or comprises acrylates, methacrylates, polybutadienes, allyl cyanurates, allyl isocyanurates, allyl esters, allyl ethers, vinyl ethers and mono or polyunsaturated oils.

7. The polymeric pipe of claim 1, wherein the co-agent is a type II co-agent.

8. The polymeric pipe of claim 1, wherein the co-agent comprises a phenyl or triazine moiety and at least three reactive carbon-carbon double bonds.

9. The polymeric pipe of claim 7, wherein the co-agent is selected from the group comprising: triallyl cyanurate (TAC), triallyl isocyanurate (TAlC), and triallyl trimellitate (TATMI).

10. The polymeric pipe of claim 1, wherein the weight ratio of peroxide initiator to co-agent is in the range of from about 20:1 to about 0.5:1.

11. The polymeric pipe of claim 1, wherein the composition further comprises an antioxidant in an amount of 0.1% to 2% by weight.

12. The polymeric pipe of claim 11, wherein the antioxidant is at least one phenolic antioxidant; and/or,
wherein the antioxidant is selected from one or more of:

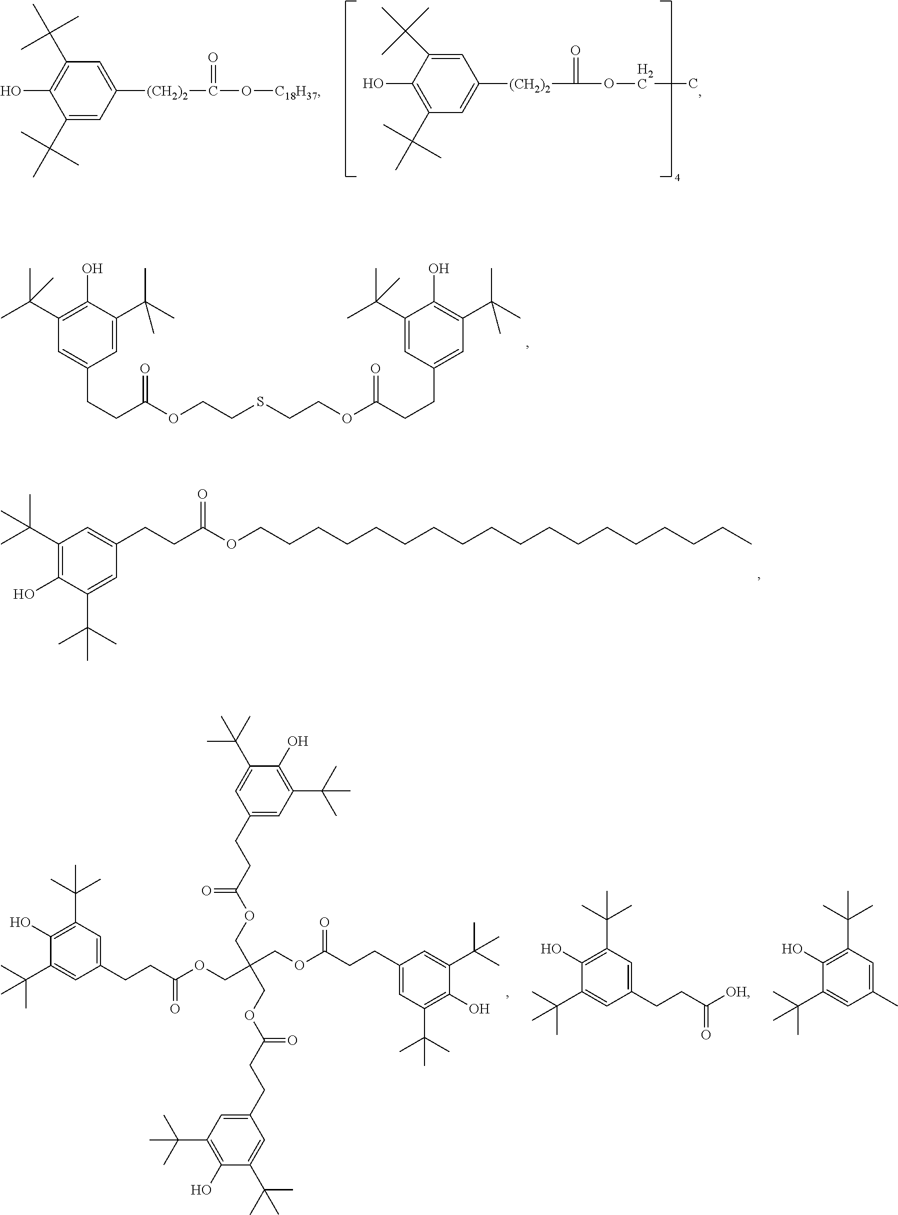

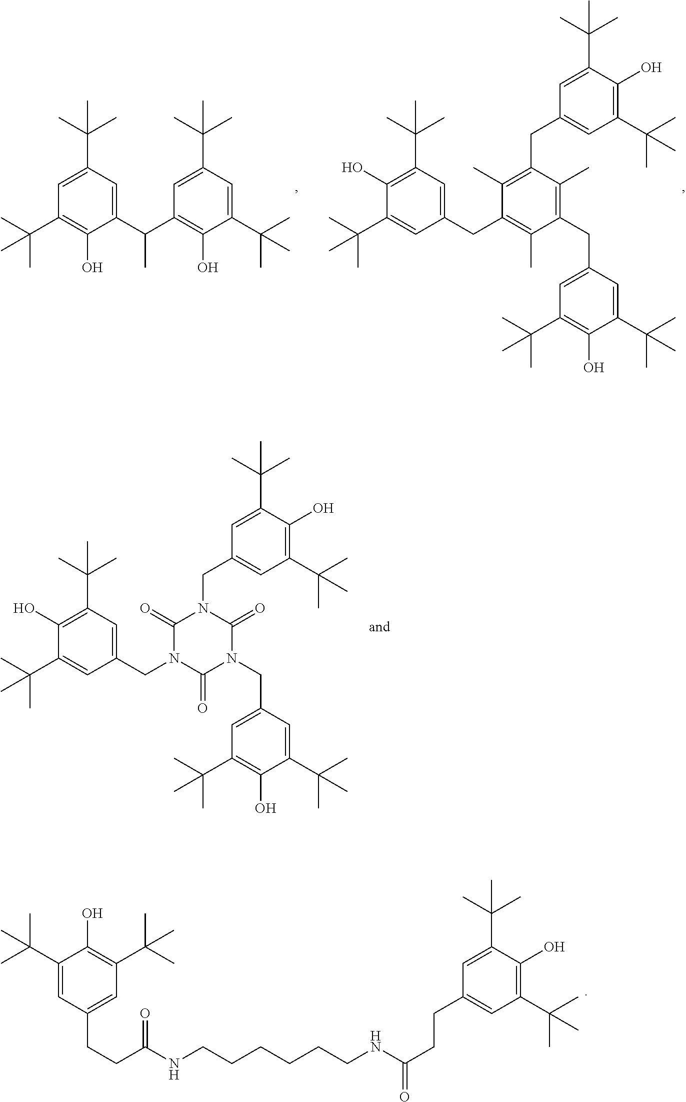

13. The polymeric pipe of claim 12, wherein the antioxidant is in an amount of 0.2% to 1% by weight.

14. The polymeric pipe of claim 1, wherein the composition further comprises a hindered amine light stabiliser (HALS) in an amount of 0.05% to 1% by weight.

15. The polymeric pipe of claim 14, wherein the hindered amine light stabiliser is selected from or comprises:
Cyasorb 3853, Chimassorb 944LD, Tinuvin 770, Tinuvin 622, Chimassorb 2020, 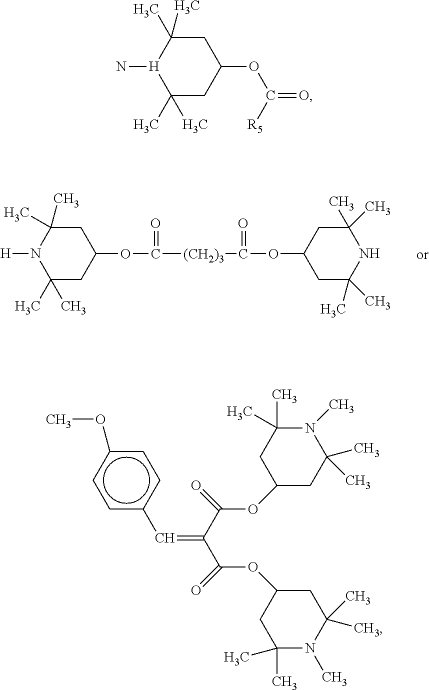
wherein R⁵ is a C₂-C₂₄ alkyl group; and/or
wherein the hindered amine light stabiliser is present in an amount of from about 0.05% to about 0.3% by weight of the composition.

16. The polymeric pipe of claim 1, wherein the composition further comprises one or more additives selected from fillers, processing aids and pigments.

17. The polymeric pipe of claim 1, wherein the peroxide crosslinking process is a PEX-a process.

18. The polymeric pipe of claim 1, wherein the pipe comprises a chemical crosslink density (CCL) of at least about 60%; and/or
wherein the pipe satisfies the NSF 600-2023 criteria for limits on the concentration of any chemical compound that may migrate into drinking water when tested in accordance with the analytical methods of NSF 61-2020.

19. A method of forming a polymeric pipe, the method comprising:
providing a mixture to an extruder;
extruding the mixture to form an extruded pipe; and
cross-linking a polyolefin structural polymer by heating the extruded pipe;
wherein the mixture is a composition comprising:
the polyolefin structural polymer,
a peroxide initiator in an amount of from about 0.2% to about 5% by weight, and
a co-agent in an amount of from about 0.02% to about 5% by weight, the co-agent comprising at least two reactive carbon-carbon double bonds.

20. The method of claim 19, wherein the mixture is prepared by dry mixing the components of the mixture prior to providing the mixture to the extruder.

21. The method of claim 19, wherein the polyolefin structural polymer and co-agent (and optionally other components) are precompounded and said precompounded components are soaked in a solution comprising peroxide to form the mixture prior to providing the mixture to the extruder.

22. The method of claim 19 wherein the heating is performed using at least one infra-red (IR) oven.

23. The method of claim 22, wherein the IR oven is in-line with an extruder that performs the extruding.

24. The method of claim 19, wherein the extruder comprises a de-gassing component; and/or
wherein the extruding provides an output of from about 25 to about 500 kg/h; and/or
wherein the polymeric pipe has a diameter in the range of from about 5 mm to about 300 mm.

25. The method of claim 19, wherein the formed polymeric pipe comprises a chemical crosslink density (CCL) of at least about 60%; and/or
wherein the pipe satisfies the NSF 600-2023 criteria for limits on the concentration of any chemical compound that may migrate into drinking water when tested in accordance with the analytical methods of NSF 61-2020.
